(19) United States
(12) Patent Application Publication
(10) Pub. No.: US 2026/0219031 A1
(43) Pub. Date: Jul. 30, 2026

(54) SCANNING CONTROL DEVICE, SCANNING SYSTEM, SCANNING CONTROL METHOD, AND RECORDING MEDIUM

(71) Applicant: NEC CORPORATION, Tokyo (JP)

(72) Inventors: John Kenji David CLARK, Tokyo (JP); Shigeru NAKAMURA, Tokyo (JP)

(73) Assignee: NEC CORPORATION, Tokyo (JP)

(21) Appl. No.: 19/143,406

(22) PCT Filed: Dec. 20, 2023
(86) PCT No.: PCT/JP2023/045713

§ 371 Date: Jun. 26, 2025

(30) Foreign Application Priority Data
Jan. 10, 2023 (JP) 2023-001478

(51) Int. Cl. G01B 9/02091; G06V 40/13

(52) U.S. Cl. CPC G01B 9/02091; G06V 40/1312

(57) ABSTRACT

A scanning control device includes a controller for scanning a first region and a second region among regions to be scanned and moving an irradiation unit toward the second region while the first region is being scanned.

### TECHNICAL FIELD

The present disclosure relates to a scanning control device, a scanning system, a scanning control method, and a recording medium.

### BACKGROUND ART

PTL 1 discloses a technique of scanning a target by scanning a laser. In PTL 1, for the purpose of capturing and displaying an image scanned at a high speed, an operation of laser scanning by scanning means and an operation of stage movement by stage means are synchronized, and laser scanning is operated while moving the stage.

### CITATION LIST

### Patent Literature

PTL 1: JP 2005-84643 A

### SUMMARY OF INVENTION

### Technical Problem

In the technique of generating an image by scanning a target as described above, there is a demand for a technique capable of scanning two or more regions freely set in the target and generating an image at a higher speed.

Therefore, an object of the disclosure is to provide a scanning control device, a scanning system, a scanning control method, and a recording medium that solve the above-described problems.

### Solution to Problem

According to a first aspect of the present disclosure, a scanning control device includes control means for scanning a first region and a second region among regions to be scanned and moving an irradiation unit toward the second region while the first region is being scanned.

According to a second aspect of the present disclosure, a scanning system includes control means for scanning a first region and a second region among regions to be scanned and moving an irradiation unit toward the second region while the first region is being scanned.

According to a third aspect of the present disclosure, a scanning control method includes scanning a first region and a second region among regions to be scanned and moving an irradiation unit toward the second region while the first region is being scanned.

According to a fourth aspect of the present disclosure, a recording medium stores a program for causing a computer of a scanning control device to function as control means for scanning a first region and a second region among regions to be scanned and moving an irradiation unit toward the second region while the first region is being scanned.

### BRIEF DESCRIPTION OF DRAWINGS

FIG. 1 is a block diagram illustrating a configuration of an optical coherence tomography image generation apparatus 1 according to some example embodiments of the present disclosure.

FIG. 2 is a block diagram illustrating a configuration of an optical coherence tomography image generation apparatus 2 according to some example embodiments of the present disclosure.

FIG. 3A is an external view of the optical coherence tomography image generation apparatus 2 according to some example embodiments of the present disclosure.

FIG. 3B is an external view of the optical coherence tomography image generation apparatus 2 according to some example embodiments of the present disclosure.

FIG. 3C is an external view of the optical coherence tomography image generation apparatus 2 according to some example embodiments of the present disclosure.

FIG. 4A is a flowchart illustrating a flow of an optical coherence tomography image generation operation performed by the optical coherence tomography image generation apparatus 2 according to some example embodiments of the present disclosure.

FIG. 4B is a flowchart illustrating a flow of the optical coherence tomography image generation operation performed by the optical coherence tomography image generation apparatus 2 according to some example embodiments of the present disclosure.

FIG. 5A is a conceptual diagram of the optical coherence tomography image generation operation performed by the optical coherence tomography image generation apparatus 2 according to some example embodiments of the present disclosure.

FIG. 5B is a conceptual diagram of the optical coherence tomography image generation operation performed by the optical coherence tomography image generation apparatus 2 according to some example embodiments of the present disclosure.

FIG. 5C is a conceptual diagram of the optical coherence tomography image generation operation performed by the optical coherence tomography image generation apparatus 2 according to some example embodiments of the present disclosure.

FIG. 5D is a conceptual diagram of the optical coherence tomography image generation operation performed by the optical coherence tomography image generation apparatus 2 according to some example embodiments of the present disclosure.

FIG. 6 is a diagram illustrating a modification of the optical coherence tomography image generation operation performed by the optical coherence tomography image generation apparatus 2 according to some example embodiments of the present disclosure.

FIG. 7 is a block diagram illustrating a configuration of an optical coherence tomography image generation apparatus 3 according to some example embodiments of the present disclosure.

FIG. 8A is a flowchart illustrating a flow of an optical coherence tomography image generation operation performed by the optical coherence tomography image generation apparatus 3 according to some example embodiments of the present disclosure.

FIG. 8B is a flowchart illustrating a flow of the optical coherence tomography image generation operation performed by the optical coherence tomography image generation apparatus 3 according to some example embodiments of the present disclosure.

FIG. 9 is a conceptual diagram of the optical coherence tomography image generation operation performed by the optical coherence tomography image generation apparatus 3 according to some example embodiments of the present disclosure.

FIG. 10 is a modification of the optical coherence tomography image generation operation performed by the optical coherence tomography image generation apparatus 3 according to some example embodiments of the present disclosure.

FIG. 11 is a flowchart illustrating a flow of a fingerprint region determination operation performed by an optical coherence tomography image generation apparatus 4 according to some example embodiments of the present disclosure.

FIG. 12 is a conceptual diagram of the fingerprint region determination operation performed by the optical coherence tomography image generation apparatus 4 according to some example embodiments of the present disclosure.

FIG. 13 illustrates a fingertip scan region determined in some example embodiments of the present disclosure.

FIG. 14 is a first diagram illustrating an outline of position control of an irradiation unit according to some example embodiments of the present disclosure.

FIG. 15 is a diagram illustrating an outline of scanning control of the irradiation unit according to some example embodiments of the present disclosure.

FIG. 16 is a first diagram illustrating the outline of scan control according to some example embodiments of the present disclosure.

FIG. 17 is a first diagram illustrating a hardware configuration of an optical coherence tomography image generation apparatus according to some example embodiments of the present disclosure.

FIG. 18 is a second diagram illustrating a hardware configuration of the optical coherence tomography image generation apparatus according to some example embodiments of the present disclosure.

FIG. 19 is a diagram illustrating a processing flow of a scan control device and a first control unit according to some example embodiments of the present disclosure.

FIG. 20 is a diagram showing a processing flow of the scan control device according to some example embodiments of the present disclosure.

FIG. 21 is a diagram illustrating a processing flow of the first control unit according to some example embodiments of the present disclosure.

FIG. 22 is a diagram illustrating a configuration of a scanning control device according to some example embodiments of the present disclosure.

FIG. 23 is a diagram illustrating a processing flow of the scanning control device illustrated in FIG. 22.

FIG. 24 is a block diagram schematically illustrating a hardware configuration example of a calculation processing device 80 capable of implementing the scanning control device according to each example embodiment of the disclosure.

### EXAMPLE EMBODIMENT

Hereinafter, an optical coherence tomography image generation apparatus including a scan control device (scanning control device) of the present disclosure will be described with reference to the drawings.

A scan control device, a scan control method, and a program according to some example embodiments of the present disclosure will be described. Hereinafter, a scan control device, a scan control method, and an optical coherence tomography image generation apparatus 1 to which a program according to some example embodiments of the present disclosure is applied will be described.

### [1-1: Configuration of Optical Coherence Tomography Image Generation Apparatus 1]

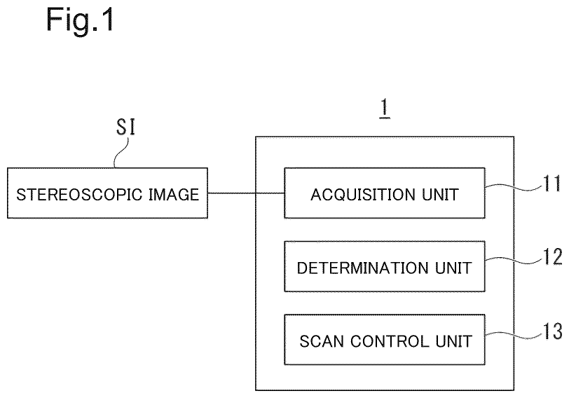

FIG. 1 is a block diagram illustrating a configuration of an optical coherence tomography image generation apparatus 1 according to some example embodiments of the present disclosure.

As illustrated in FIG. 1, the optical coherence tomography image generation apparatus 1 includes an acquisition unit 11, a determination unit 12, and a scan control unit 13. The acquisition unit 11 acquires a stereoscopic image SI of a target. The determination unit 12 determines a plurality of scanning regions on the target based on the stereoscopic image SI. The scan control unit 13 moves an irradiation position of light for capturing an optical coherence tomography image of the target relative to the target, and controls scanning by light of each of the plurality of scanning regions.

The acquisition unit 11 acquires information of at least two scan regions in the target and a reference position specified in each of the scan regions and used to specify a position of an irradiation unit that irradiates scanning light on the scan region.

The scan control unit 13 acquires information of at least two scanning regions in the scanning target and a reference position used to specify a position of the irradiation unit that irradiates scanning light on the scanning regions. Then, the scan control unit 13 performs control of moving the position of the irradiation unit from a start position at which the reference position is first aligned in a region set in the first scanning region to a start position at which the reference position is first aligned in a second scanning region to be scanned next while the first scanning region to be scanned in advance among the scanning regions is being scanned.

### [1-2: Technical Effect of Optical Coherence Tomography Image Generation Apparatus 1]

By using the stereoscopic image SI, the optical coherence tomography image generation apparatus 1 can easily and accurately determine a plurality of scanning regions and generate an accurate optical coherence tomography image. The optical coherence tomography image generation apparatus 1 performs control of moving the position of the irradiation unit from the reference position of the first scan region to the reference position of the second scan region on which scanning is to be performed next while the scanning of the first scan region on which scanning is to be performed in advance among the scan regions is being performed. As a result, the optical coherence tomography image generation apparatus 1 can scan two or more regions freely set in the target and generate an image at a higher speed.

A scan control device, a scan control method, and a program according to some example embodiments of the present disclosure will be described. Hereinafter, description will be given with reference to the scan control device, the scan control method, and an optical coherence tomography image generation apparatus 2 to which a program according to some example embodiments of the present disclosure is applied.

### [2-1: Configuration of Optical Coherence Tomography Image Generation Apparatus 2]

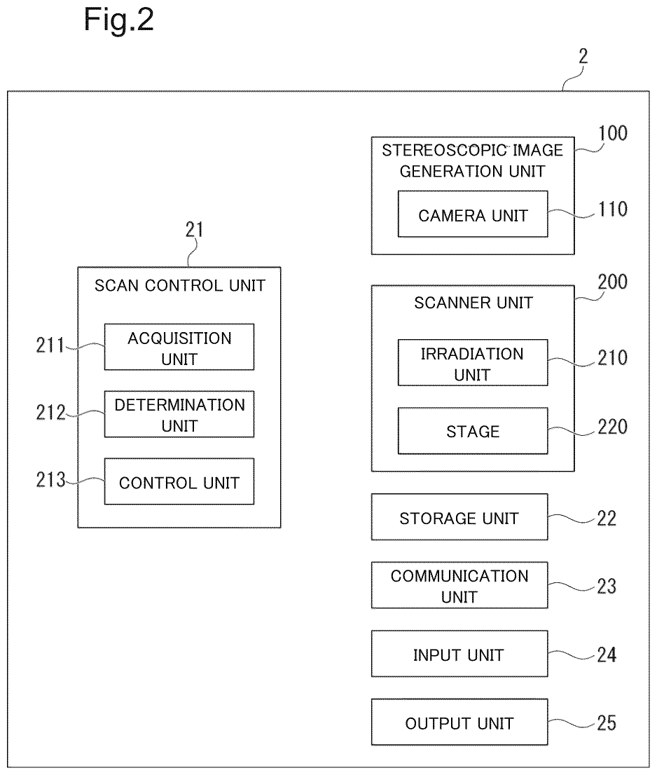

A configuration of the optical coherence tomography image generation apparatus 2 will be described with reference to FIG. 2. FIG. 2 is a block diagram illustrating a configuration of the optical coherence tomography image generation apparatus 2.

As illustrated in FIG. 2, the optical coherence tomography image generation apparatus 2 includes a scan control unit 21 as an aspect of a scan control device (scanning control device), and a storage unit 22. The optical coherence tomography image generation apparatus 2 may also include a stereoscopic image generation unit 100, a scanner unit 200, a communication unit 23, an input unit 24, and an output unit 25. However, the optical coherence tomography image generation apparatus 2 may not include at least one of the stereoscopic image generation unit 100, the scanner unit 200, the communication unit 23, the input unit 24, and the output unit 25. When the optical coherence tomography image generation apparatus 2 does not include at least one of the stereoscopic image generation unit 100 and the scanner unit 200, the optical coherence tomography image generation apparatus 2 may transmit and receive information to and from the stereoscopic image generation unit 100 and the scanner unit 200 via the communication unit 23. The scan control unit 21, the storage unit 22, the stereoscopic image generation unit 100, the scanner unit 200, the communication unit 23, the input unit 24, and the output unit 25 are connected via a communication line. The scan control unit 21, the storage unit 22, the stereoscopic image generation unit 100, the scanner unit 200, the communication unit 23, the input unit 24, and the output unit 25 may be communicably connected by any method as long as the units are communicably connected wired or wireless. Each of the scan control unit 21, the storage unit 22, the stereoscopic image generation unit 100, the scanner unit 200, the communication unit 23, the input unit 24, and the output unit 25 may be configured as a device and may be configured as an optical coherence tomography image generation system. The scanner unit 200 is an aspect of an optical coherence tomography device. The scanning system includes, for example, the scan control unit 21 and the scanner unit 200. The scanning system may include each unit that configures the optical coherence tomography image generation system.

The scan control unit 21 includes, for example, at least one of a central processing unit (CPU), a graphics processing unit (GPU), and a field programmable gate array (FPGA). The scan control unit 21 reads a computer program. For example, the scan control unit 21 may read a computer program stored in the storage unit 22. For example, the scan control unit 21 may read a computer program stored in a computer-readable non-transitory recording medium using a recording medium reading device (for example, an input unit 24 to be described later) not illustrated and provided in the optical coherence tomography image generation apparatus 2. The scan control unit 21 may acquire a computer program from devices not illustrated and disposed outside the optical coherence tomography image generation apparatus 2 via the communication unit 23 (alternatively, another communication device) (that is, the computer program may be downloaded or read). The scan control unit 21 executes the read computer program. As a result, logical functional blocks for executing operations to be performed by the optical coherence tomography image generation apparatus 2 are achieved in the scan control unit 21. That is, the scan control unit 21 can function as a controller that achieves logical functional blocks for executing operations (in other words, processing) to be performed by the optical coherence tomography image generation apparatus 2.

FIG. 2 illustrates an example of logical functional blocks achieved in the scan control unit 21 to execute the optical coherence tomography image generation operation. As illustrated in FIG. 2, an acquisition unit 211, a determination unit 212, and a control unit 213 are achieved in the scan control unit 21. The operations of the acquisition unit 211, the determination unit 212, and the control unit 213 will be described later.

The storage unit 22 can store desired data. For example, the storage unit 22 may temporarily store a computer program executed by the scan control unit 21. The storage unit 22 may temporarily store data temporarily used by the scan control unit 21 when the scan control unit 21 executes a computer program. The storage unit 22 may store data to be stored by the optical coherence tomography image generation apparatus 2 for a long period. The storage unit 22 may include at least one of a random access memory (RAM), a read only memory (ROM), a hard disk device, a magneto-optical disk device, a solid state drive (SSD), and a disk array device. That is, the storage unit 22 may include a non-transitory recording medium.

The communication unit 23 can communicate with devices outside the optical coherence tomography image generation apparatus 2 via a communication network (not illustrated). The communication unit 23 may be a communication interface conforming with a standard such as Ethernet (registered trademark), Wi-Fi (registered trademark), Bluetooth (registered trademark), or a universal serial bus (USB). When the communication unit 23 is a communication interface conforming with a USB standard, the communication unit 23 may be capable of communicating between, for example, the scan control unit 21 including FPGA and a mechanism including a computer that controls the entire optical coherence tomography image generation apparatus 2.

The input unit 24 is a device that receives information input from outside the optical coherence tomography image generation apparatus 2 to the optical coherence tomography image generation apparatus 2. For example, the input unit 24 may include an operation device (for example, at least one of a keyboard, a mouse trackball, a touch panel, a pointing device such as a pen tablet, a button, and the like) operable by an operator of the optical coherence tomography image generation apparatus 2. For example, the input unit 24 may include a reading device capable of reading information recorded as data on a recording medium externally attachable to the optical coherence tomography image generation apparatus 2.

The output unit 25 is a device that outputs information to outside the optical coherence tomography image generation apparatus 2. For example, the output unit 25 may output information as an image. That is, the output unit 25 may include a display device (a so-called display) capable of displaying an image indicating information desired to be output. Examples of the display device include a liquid crystal display, an organic light emitting diode (OLED) display, and the like. For example, the output unit 25 may output information as a voice. That is, the output unit 25 may include an audio device (a so-called speaker) capable of outputting a voice. For example, the output unit 25 may output information on paper. That is, the output unit 25 may include a printing device (a so-called printer) capable of printing desired information on paper. The input unit 24 and the output unit 25 may be integrally formed as a touch panel.

The hardware configuration illustrated in FIG. 2 is merely an example, and devices other than the devices illustrated in FIG. 2 may be added, or some devices may not be provided. Some devices may be replaced with other devices having a similar function. Some functions of some example embodiments of the present disclosure may be provided by other devices via a network. The functions of some example embodiments of the present disclosure may be achieved by being distributed in a plurality of devices. As such, the hardware configuration illustrated in FIG. 2 can be changed as appropriate.

### [2-2: Stereoscopic Image Generation Unit 100]

The stereoscopic image generation unit 100 generates the stereoscopic image SI of the target. The stereoscopic image generation unit 100 may be a stereo camera. The stereoscopic image generation unit 100 may include at least two camera units 110 located at different positions relative to the target. The stereoscopic image generation unit 100 may include at least two camera units 110 having different imaging angles relative to the target. The stereoscopic image generation unit 100 may generate the stereoscopic image SI from a plurality of target images captured from different angles. The stereoscopic image SI generated by the stereoscopic image generation unit 100 may be used to acquire a three-dimensional position of a region to be subjected to optical coherence tomography scanning of the target. The stereoscopic image generation unit 100 may generate the stereoscopic image SI capable of acquiring the three-dimensional position of each portion of the target.

Generation operation of the stereoscopic image SI by the stereoscopic image generation unit 100 may be controlled by the control unit 213. The control unit 213 may perform movement control and imaging control of the camera unit 110.

### [2-3: Scanner Unit 200]

The scanner unit 200 irradiates a target with a light beam while performing two-dimensional scanning, performs optical coherence tomography, and generates three-dimensional luminance data of the target. The scanner unit 200 includes an irradiation unit 210 (lens and galvano scanner) and a stage 220 (moving unit).

The optical coherence tomography is a technique of specifying a position in an optical axis direction, that is, in a depth direction of the target, of a light scattering point at which object light is scattered in the target, by using interference between object light and reference light, and obtaining structure data of inside the target spatially resolved in the depth direction. Optical coherence tomography techniques include a time domain (TD-OCT) scheme and a Fourier domain (FD-OCT) scheme, and some example embodiments of the present disclosure adopt the FD-OCT scheme. In the FD-OCT scheme, when object light and reference light interfere with each other, an interference light spectrum in a wide wavelength band is measured, and Fourier transform is performed on the interference light spectrum to obtain structure data in the depth direction. As methods of obtaining an interference light spectrum, there are a spectral domain (SD-OCT) scheme using a spectrometer and a swept source (SS-OCT) scheme using a light source that sweeps a wavelength, and the optical coherence tomography image generation apparatus 2 according to some example embodiments of the present disclosure performs optical coherence tomography scanning in the SS-OCT scheme. By scanning the irradiation position of object light in an in-plane direction perpendicular to the depth direction of the target, the scanner unit 200 can obtain tomographic structure data spatially resolved in the in-plane direction and spatially resolved in the depth direction, that is, three-dimensional tomographic structure data of the measurement target.

The scanner unit 200 may include a light source and a signal processing unit. The optical coherence tomography operation of the scanner unit 200 may be controlled by the control unit 213. The control unit 213 may control movement, scanning position, and scanning speed of the irradiation unit 210 provided in the scanner unit 200. The control unit 213 may control movement of the irradiation unit 210 by performing movement control of the stage 220 provided in the scanner unit 200.

The light source may emit light while sweeping a wavelength. The scanner unit 200 irradiates a target with object light emitted from the light source and scatters object light. Object light scattered from the target and reference light reflected by a reference light mirror interfere with each other, and two interference lights are generated. That is, an intensity ratio of the two interference lights is determined by a phase difference between object light and reference light. The scanner unit 200 outputs an electric signal to the signal processing unit according to the intensity difference between the two interference lights. The signal processing unit performs a process of converting the electrical signal output from the scanner unit 200 into data. The signal processing unit performs Fourier transform on the generated interference light spectrum data and acquires data indicating an intensity of backscattered light (object light) at different depth positions in the depth direction (also referred to as “Z direction”).

The operation of acquiring data indicating the intensity of backscattered light (object light) in the depth direction (Z direction) at the irradiation position of object light in the target is referred to as “A scan”. The signal processing unit generates a waveform indicating an object light backscattering intensity at Nz points as an A-scan waveform. The scanner unit 200 scans the irradiation position of object light in the target using the irradiation unit 210. The scanner unit 200 moves the irradiation position of object light in the scanning line direction (also referred to as “fast axis direction of scanning” and “X direction”) using the irradiation unit 210. The signal processing unit repeatedly performs the A-scan operation for each irradiation position of object light, and connects A-scan waveforms of each irradiation position of object light. As a result, the signal processing unit acquires a two-dimensional map of intensity of backscattered light (object light) in the scanning line direction (X direction) and the depth direction (Z direction) as a tomographic image. Hereinafter, the operation of repeatedly performing the A scan operation while moving in the scanning line direction (fast axis direction of scanning, X direction) and connecting the measurement results is referred to as “B scan”. Assuming that irradiation position of object light for each B scan is at Nx points, a tomographic image by B scan is two-dimensional luminance data indicating an object light backscattering intensity at Nz×Nx points.

The scanner unit 200 moves the irradiation position of object light in the scanning line direction (X direction) and also in a direction perpendicular to the scanning line (also referred to as “slow axis direction of scanning” and “Y direction”) using the irradiation unit 210. The signal processing unit repeats the B-scan operation and connects the B-scan measurement results. As a result, the signal processing unit acquires three-dimensional tomographic structure data. Hereinafter, the operation of repeatedly performing the B scan operation while moving in the direction perpendicular to the scanning line (Y direction) and connecting the measurement results is referred to as “C scan”. When the number of B scans performed for each C scan is Ny times, tomographic structure data obtained by the C scan is three-dimensional luminance data indicating an object light backscattering intensity at Nz×Nx×Ny points.

The signal processing unit transmits data as a result of the data conversion process to the scan control unit 21. The operation by the signal processing unit may be performed by the scan control unit 21.

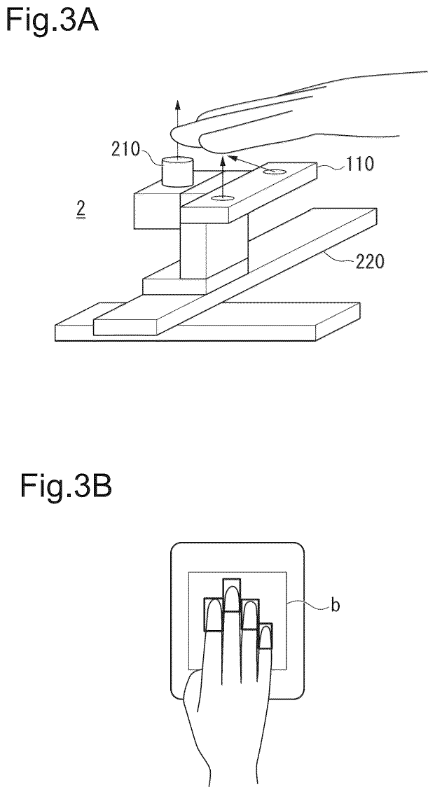

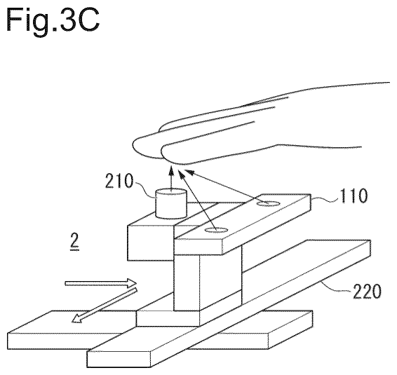

FIG. 3A is an external view of the optical coherence tomography image generation apparatus 2. As illustrated in FIG. 3A, the irradiation unit 210 and the camera unit 110 may be fixed to the same stage 220 and integrated. The stage 220 is a pedestal on which the irradiation unit 210 and the camera unit 110 are mounted and including a mechanism that moves positions of the irradiation unit 210 and the camera unit 110 to a scanning region of a hand as a scanning target (region to be scanned).

The optical coherence tomography image generation apparatus 2 may capture fingers of a hand. As illustrated in FIG. 3B, the optical coherence tomography image generation apparatus 2 may have a configuration in which a palm is faced downward and the fingers of the hand are held above the camera unit 110 and the irradiation unit 210 of the stereoscopic image generation unit 100. FIG. 3B illustrates an imaging region b of the stereoscopic image generation unit 100. In the example illustrated in FIG. 3B, the stereoscopic image generation unit 100 may capture the stereoscopic image SI of one hand from the second finger to the fourth finger. Alternatively, the optical coherence tomography image generation apparatus 2 may be configured to place the hand on a placing table with the palm facing upward and capture the fingers of the hand from above.

The control unit 213 may move the position of the irradiation unit 210 according to the scanning region determined based on the stereoscopic image SI. As illustrated in FIG. 3C, the irradiation unit 210 and the camera unit 110 may be fixed to the same stage 220 and integrally moved. Alternatively, the position of the irradiation unit 210 and the position of the camera unit 110 may be moved separately.

Incidentally, there is an upper limit to the size of the region of which three-dimensional luminance data can be obtained by performing one C scan. For example, compared with the size of the region that can be included in the stereoscopic image SI by generating the stereoscopic image SI once, the size of the region of which three-dimensional luminance data can be obtained by C scan is much smaller. Meanwhile, by determining a three-dimensional position of a desired region of which three-dimensional luminance data is desired to be obtained in advance, it is possible to efficiently acquire three-dimensional luminance data of the desired region with high accuracy. Therefore, the optical coherence tomography image generation apparatus 2 determines a plurality of scanning regions on the target based on the stereoscopic image SI before generating the optical coherence tomography image.

### [2-4: Optical Coherence Tomography Image Generation Operation Performed by Optical Coherence Tomography Image Generation Apparatus 2]

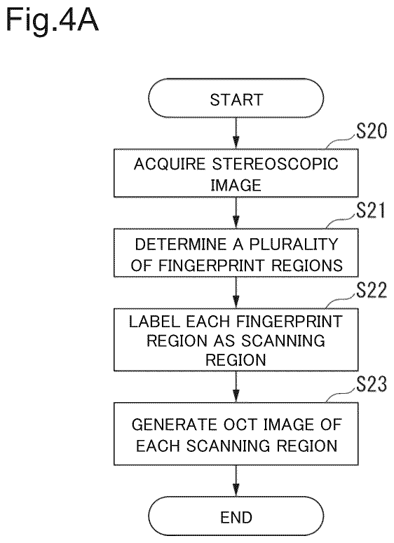

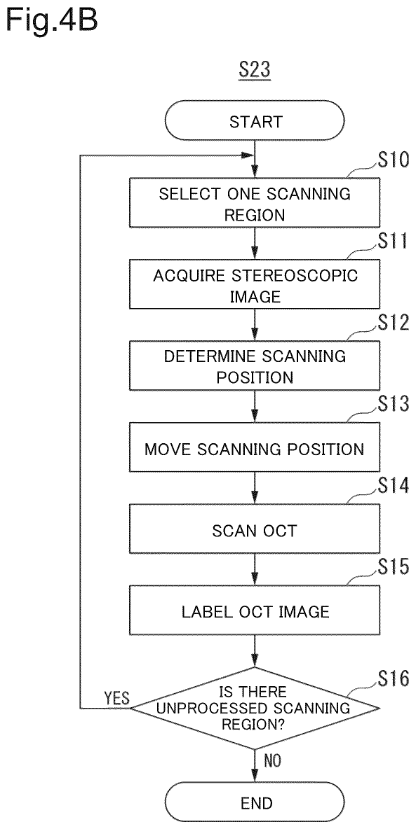

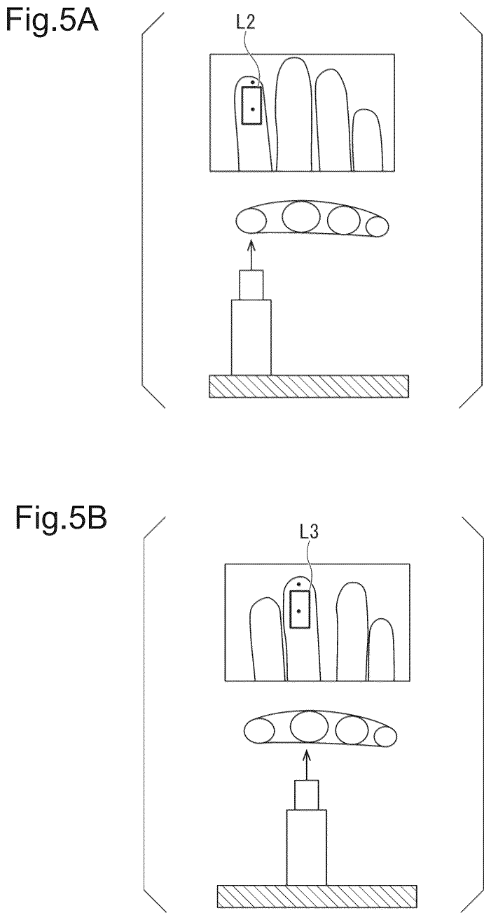

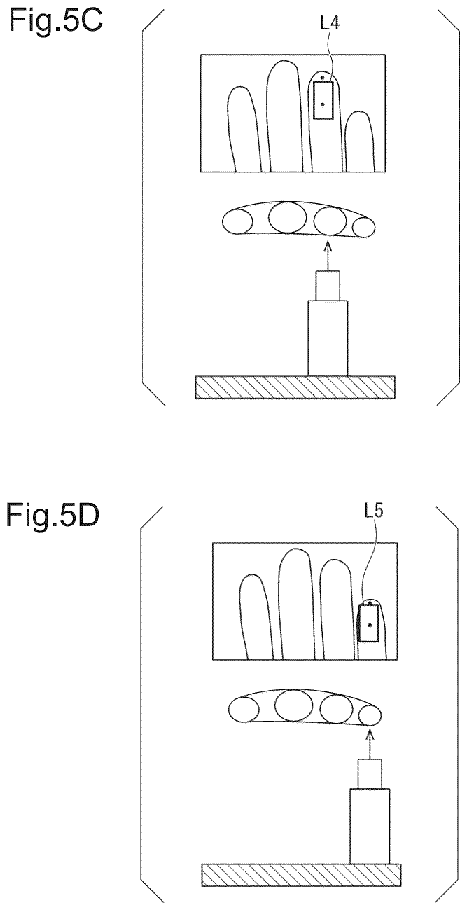

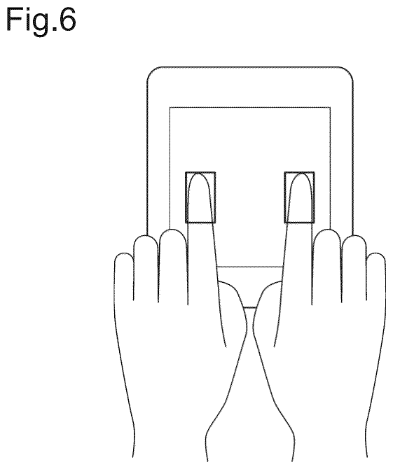

A flow of an optical coherence tomography image generation operation performed by the optical coherence tomography image generation apparatus 2 will be described with reference to FIGS. 4A to 5D. FIGS. 4A and 4B are flowcharts illustrating a flow of the optical coherence tomography image generation operation performed by the optical coherence tomography image generation apparatus 2. FIGS. 5A to 5D are conceptual diagrams of the optical coherence tomography image generation operation performed by the optical coherence tomography image generation apparatus 2.

In some example embodiments of the present disclosure, the target of the optical coherence tomography imaging may be a hand. In some example embodiments of the present disclosure, the determination unit 212 may determine a fingerprint region of each of two or more fingers among the fingers of the hand as the plurality of scanning regions based on the stereoscopic image SI.

As illustrated in FIG. 4A, the acquisition unit 211 acquires the stereoscopic image SI of the hand as the target (step S20). The acquisition unit 211 may acquire the stereoscopic image SI of the hand generated by the stereoscopic image generation unit 100.

The determination unit 212 determines the fingerprint region of each of two or more fingers among the fingers of the hand as the plurality of scanning regions based on the stereoscopic image SI (step S21). The determination unit 212 may estimate fingertips of two or more fingers among the fingers of the hand based on the stereoscopic image SI of the hand, and determine a fingerprint region including at least a part of a region from the fingertip toward the base of the finger to the first joint on the finger as at least one of the plurality of scanning regions. As illustrated in FIGS. 5A to 5D, the determination unit 212 may determine each of (a) a fingerprint region L2 of the second finger, (b) a fingerprint region L3 of the third finger, (c) a fingerprint region L4 of the fourth finger, and (d) a fingerprint region L5 of the fifth finger of the left hand as the plurality of scanning regions. For example, as illustrated in FIGS. 5A to 5D, the determination unit 212 may determine a rectangular region of each finger as the fingerprint region.

The determination unit 212 labels each of the plurality of fingerprint regions (step S22). For example, as illustrated in FIGS. 5A to 5D, the determination unit 212 may label (a) the fingerprint region of the second finger of the left hand as “L2”. The determination unit 212 may label (b) the fingerprint region of the third finger of the left hand as “L3”. The determination unit 212 may label (c) the fingerprint region of the fourth finger of the left hand as “L4”. The determination unit 212 may label (d) the fingerprint region of the fifth finger of the left hand as “L5”.

The control unit 213 generates an optical coherence tomography image of each scanning region (step S23). The operation of step S23 is illustrated in FIG. 4B. As illustrated in FIG. 4B, the control unit 213 selects one fingerprint region among a plurality of fingerprint regions (step S10). For example, the determination unit 212 may first select the fingerprint region L2 of the second finger of the left hand.

The acquisition unit 211 acquires the stereoscopic image SI of the selected one fingerprint region (step S11). The acquisition unit 211 may acquire the stereoscopic image SI of one fingerprint region generated by the stereoscopic image generation unit 100. Note that the control unit 213 may not acquire the stereoscopic image SI of the one selected fingerprint region. Since the operation of acquiring the stereoscopic image SI of the fingerprint region in step S11 is a process for a case where the hand moves, for example, the operation of acquiring the stereoscopic image SI of the fingerprint region may be omitted for the first selected one fingerprint region.

The determination unit 212 determines the optical coherence tomography scanning position according to the selected one fingerprint region based on the stereoscopic image SI (step S12). The optical coherence tomography scanning position is a scanning start position and a scanning end position in the fingerprint region, a start position in the fingerprint region at which the lens of the irradiation unit 210 is aligned at the start of scanning, and a final position in the fingerprint region at which the lens of the irradiation unit 210 is aligned at the end of scanning.

The control unit 213 outputs scan control information including the optical coherence tomography scanning position, and moves a lens position of the irradiation unit 210 to the optical coherence tomography scanning position according to the one fingerprint region (step S13). For example, as illustrated in the lower part of FIGS. 5A to 5D, the control unit 213 may move the lens position of the irradiation unit 210 to the optical coherence tomography scanning position according to the region selected among the fingerprint regions L2, L3, L4, and L5.

The control unit 213 moves an irradiation position of light for capturing an optical coherence tomography image of the one fingerprint region relative to the one fingerprint region, and controls scanning of the one fingerprint region by light (step S14). The control unit 213 may control optical coherence tomography scanning by the irradiation unit 210.

The determination unit 212 labels the captured optical coherence tomography image of one fingerprint region with the same label as the fingerprint region (step S15).

The determination unit 212 determines whether there is a fingerprint region for which the processes from step S10 to step S15 are not executed yet (step S16). When there is a fingerprint region for which the processes from step S10 to step S15 are not executed yet (step S16: Yes), the process proceeds to step S10. In step S10, the determination unit 212 may next select the fingerprint region L3 of the third finger of the left hand. The determination unit 212 may next select the fingerprint region L4 of the fourth finger of the left hand. Finally, the determination unit 212 may select the fingerprint region L5 of the fifth finger of the left hand.

Here, the fingerprint region described above is an aspect of the scanning region. The control unit 213 performs control to sequentially perform optical coherence tomography scanning (scanning) on the fingerprint regions L2 to L5. Here, the control unit 213 performs control of moving the position of the irradiation unit from a start position at which the reference position is first aligned in a region set in the first scanning region to a start position at which the reference position is first aligned in a second scanning region to be scanned next while the first scanning region to be scanned in advance among the scanning regions is being scanned.

When there is no fingerprint region for which the processes from step S10 to step S15 are not executed yet (step S16: No), the optical coherence tomography image generation operation performed by the optical coherence tomography image generation apparatus 2 ends. The determination unit 212 may determine how many fingers are shown in the stereoscopic image SI before scanning control and repeat the processes from step S10 to step S15 for the number of fingers for each fingerprint region as the target of scanning control, and the control unit 213 may output scan control information including the optical coherence tomography scanning position for each fingerprint region.

FIG. 6 is a diagram illustrating a modification of the optical coherence tomography image generation operation performed by the optical coherence tomography image generation apparatus.

With reference to FIGS. 5A to 5D, a case where the optical coherence tomography image generation apparatus 2 generates the optical coherence tomography image of the second finger to the fourth finger of one hand is described, but the present invention is not limited to generation of the optical coherence tomography image of fingers of one hand. For example, as illustrated in FIG. 6, the optical coherence tomography image generation apparatus 2 may generate optical coherence tomography images of fingers of both hands.

### [2-5: Technical Effect of Optical Coherence Tomography Image Generation Apparatus 2]

The optical coherence tomography image generation apparatus 2 can generate optical coherence tomography images of a plurality of locations. Although the size of the optical coherence tomography image that can be obtained by one optical coherence tomographic scanning operation is fixed, the optical coherence tomography image generation apparatus 2 can easily and accurately determine the fingerprint region of the finger of the hand by using the stereoscopic image SI, and can generate a desired optical coherence tomography image. The optical coherence tomography image generation apparatus 2 also performs control of moving the position of the irradiation unit from the reference position of the first scan region to the reference position of the second scan region on which scanning is to be performed next while the scanning of the first scan region on which scanning is to be performed in advance among the scan regions is being performed. As a result, the optical coherence tomography image generation apparatus 2 can scan two or more regions freely set in the target and generate an image at a higher speed.

A scan control device, a scan control method, and a program according to some example embodiments of the present disclosure will be described. Hereinafter, the description will be given with reference to the scan control device, the scan control method, and an optical coherence tomography image generation apparatus 3 to which a program according to some example embodiments of the present disclosure is applied.

### [3-1: Configuration of Optical Coherence Tomography Image Generation Apparatus 3]

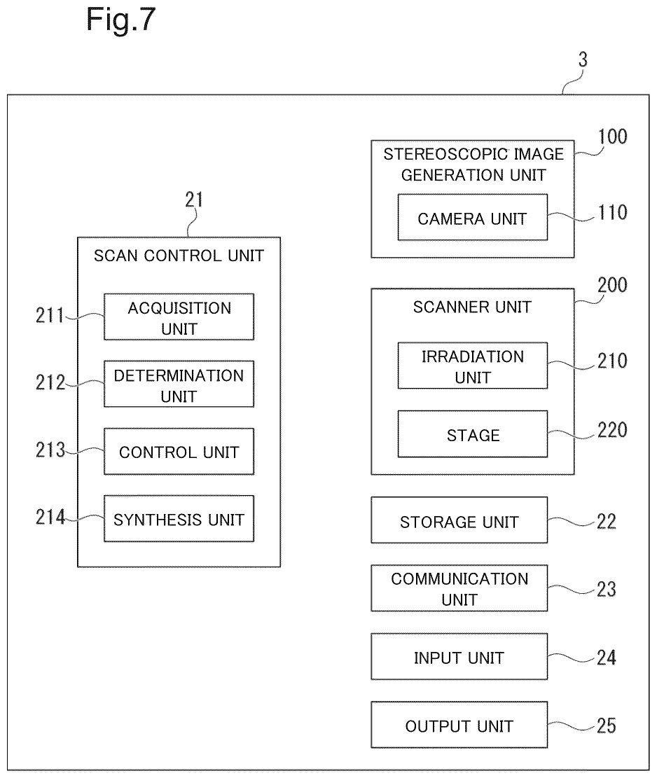

A configuration of the optical coherence tomography image generation apparatus 3 will be described with reference to FIG. 7. FIG. 7 is a block diagram illustrating a configuration of the optical coherence tomography image generation apparatus 3.

As illustrated in FIG. 7, similarly to the optical coherence tomography image generation apparatus 2, the optical coherence tomography image generation apparatus 3 includes a scan control unit 21 as an aspect of the scan control device (scanning control device), and a storage unit 22. Similarly to the optical coherence tomography image generation apparatus 2, the optical coherence tomography image generation apparatus 3 may also include a communication unit 23, an input unit 24, and an output unit 25. However, the optical coherence tomography image generation apparatus 3 may not include at least one of the communication unit 23, the input unit 24, and the output unit 25. The optical coherence tomography image generation apparatus 3 is different from the optical coherence tomography image generation apparatus 2 in that a determination operation is performed by the determination unit 212 and the determination unit 212 provided in the scan control unit 21 includes a synthesis unit 214. The synthesis unit 214 generates an optical coherence tomography image of a desired region based on an optical coherence tomography image of each scanning region. Other features of the optical coherence tomography image generation apparatus 3 may be the same as other features of the optical coherence tomography image generation apparatus 2.

### [3-2: Optical Coherence Tomography Image Generation Operation by Optical Coherence Tomography Image Generation Apparatus 3]

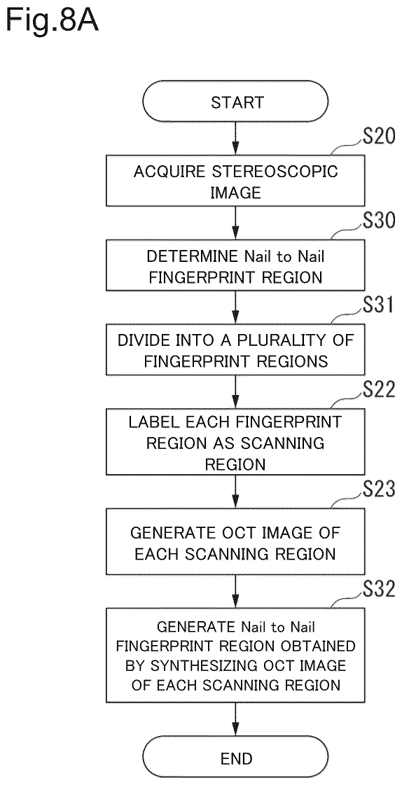

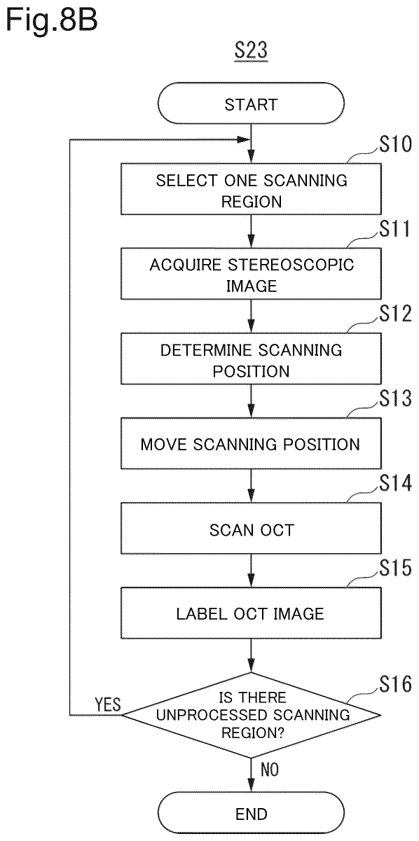

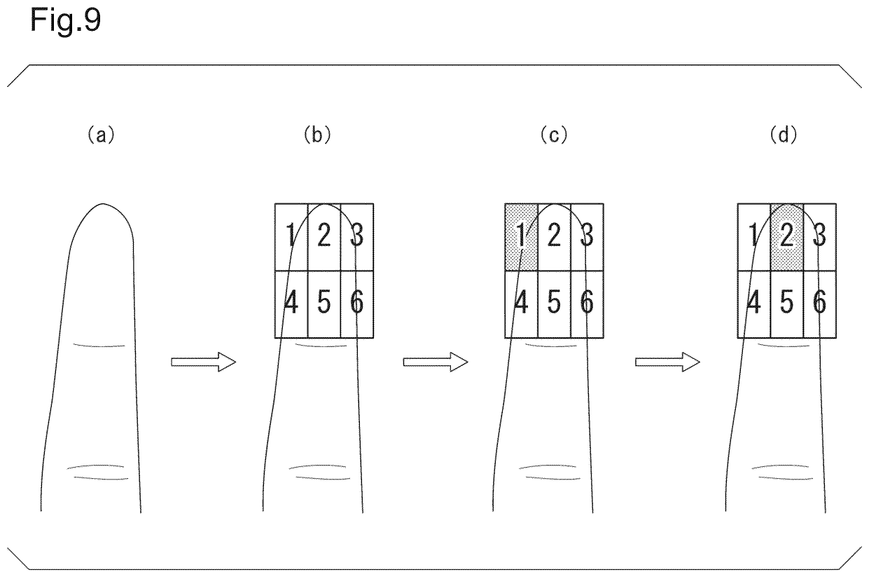

A flow of an optical coherence tomography image generation operation performed by the optical coherence tomography image generation apparatus 3 will be described with reference to FIGS. 8A to 9. FIGS. 8A and 8B are flowcharts illustrating a flow of the optical coherence tomography image generation operation performed by the optical coherence tomography image generation apparatus 3. FIG. 9 is a conceptual diagram of the optical coherence tomography image generation operation performed by the optical coherence tomography image generation apparatus 3.

In some example embodiments of the present disclosure, the target of the optical coherence tomography image generation may be a hand. In some example embodiments of the present disclosure, the determination unit 212 determines an imaging region on the target based on the stereoscopic image SI, and divides the imaging region to determine a plurality of scanning regions.

As illustrated in FIG. 8A, the acquisition unit 211 acquires the stereoscopic image SI of the hand as the target (step S20). For example, as illustrated in part (a) of FIG. 9, the acquisition unit 211 may acquire the stereoscopic image SI of one of the fingers of the hand.

The determination unit 212 determines a Nail to Nail fingerprint region as an imaging region on the finger based on the stereoscopic image SI (step S30). For example, as illustrated in part (b) of FIG. 9, the determination unit 212 may determine a rectangular region including the fingerprint of the entire region from the fingertip of the finger to the first joint as the Nail to Nail fingerprint region. The determination unit 212 may estimate the fingertip of at least one finger of the hand based on the stereoscopic image SI of the hand, and determine a fingerprint region including at least a part of a region from the fingertip toward the base of the finger to the first joint on the finger. The determination unit 212 may determine a fingerprint region having a size larger than an image size that can be obtained by one optical coherence tomography scanning based on the stereoscopic image SI of the hand.

The determination unit 212 divides the Nail to Nail fingerprint region and determines a plurality of fingerprint regions as a plurality of scanning regions (step S31). For example, as illustrated in part (b) of FIG. 9, the determination unit 212 may divide the Nail to Nail fingerprint region into six, and determine six fingerprint regions.

The determination unit 212 labels each of the plurality of fingerprint regions (step S22). For example, as shown in part (b) of FIG. 9, the determination unit 212 may label the fingerprint region at the upper left of the Nail to Nail fingerprint region as “1”. The determination unit 212 may label the fingerprint region at the upper middle of the Nail to Nail fingerprint region as “2”. The determination unit 212 may label the fingerprint region at the upper right of the Nail to Nail fingerprint region as “3”. The determination unit 212 may label the fingerprint region at the lower left of the Nail to Nail fingerprint region as “4”. The determination unit 212 may label the fingerprint region at the lower middle of the Nail to Nail fingerprint region as “5”. The determination unit 212 may label the fingerprint region at the lower right of the Nail to Nail fingerprint region as “6”.

The control unit 213 generates an optical coherence tomography image of each scanning region (step S23). The operation of step S23 is illustrated in FIG. 8B. As illustrated in FIG. 8B, the control unit 213 selects one fingerprint region among a plurality of fingerprint regions (step S10). For example, as illustrated in part (c) of FIG. 9, the determination unit 212 may first select an upper left region 1.

The acquisition unit 211 acquires the stereoscopic image SI of the selected one fingerprint region (step S11). Note that, similarly to some example embodiments of the present disclosure, the control unit 213 may not acquire the stereoscopic image SI of the one selected fingerprint region.

The determination unit 212 determines the OCT scanning position according to the selected one fingerprint region based on the stereoscopic image SI (step S12). The OCT scanning position is a scanning start position and a scanning end position in the fingerprint region, a start position in the fingerprint region at which the lens of the irradiation unit 210 is aligned at the start of scanning, and a final position in the fingerprint region at which the lens of the irradiation unit 210 is aligned at the end of scanning.

The control unit 213 outputs scan control information including the OCT scanning position, and moves the lens position of the irradiation unit 210 to the OCT scanning position according to the one fingerprint region (step S13). For example, as illustrated in part (c) of FIG. 9, the control unit 213 may move the lens position of the irradiation unit 210 to the OCT scanning position according to the first selected upper left region 1.

The control unit 213 moves an irradiation position of light for capturing an optical coherence tomography image of the one fingerprint region relative to the one fingerprint region, and controls scanning of the one fingerprint region by light (step S14). The control unit 213 may control OCT scanning by the irradiation unit 210.

The determination unit 212 labels the captured optical coherence tomography image of one fingerprint region with the same label as the fingerprint region (step S15).

The determination unit 212 determines whether there is a fingerprint region for which the processes from step S10 to step S15 are not executed yet (step S16). When there is a fingerprint region for which the processes from step S10 to step S15 are not executed yet (step S16: Yes), the process proceeds to step S10. In step S10, for example, as illustrated in part (d) of FIG. 9, the determination unit 212 may next select an upper middle region 2. The determination unit 212 may sequentially select the upper right region 3, the lower left region 4, the lower middle region 5, and the lower right region 6.

Here, the scan control unit 21 performs control such that optical coherence tomography scanning (scanning) is sequentially performed on the fingerprint regions (scan regions) 1 to 6. Here, the scan control unit 21 performs control of moving the position of the irradiation unit from a start position at which the reference position is first aligned in a region set in the first scanning region to a start position at which the reference position is first aligned in a second scanning region to be scanned next while the first scanning region to be scanned in advance among the scanning regions is being scanned.

When there is no fingerprint region for which the processes from step S10 to step S15 are not executed yet (step S16: No), the process proceeds to step S32. The determination unit 212 may repeat the processes from step S10 to step S15 for the number of divisions of the Nail to Nail fingerprint regions before scanning control, and the control unit 213 may output the scan control information including the OCT layer scanning position for each of the fingerprint regions.

The synthesis unit 214 generates a Nail to Nail fingerprint image obtained by synthesizing the optical coherence tomography image of each of the fingerprint regions (step S32).

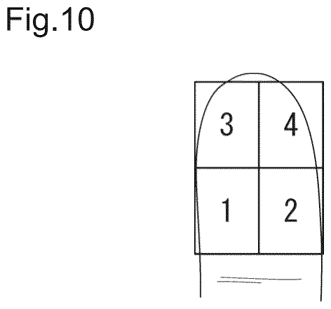

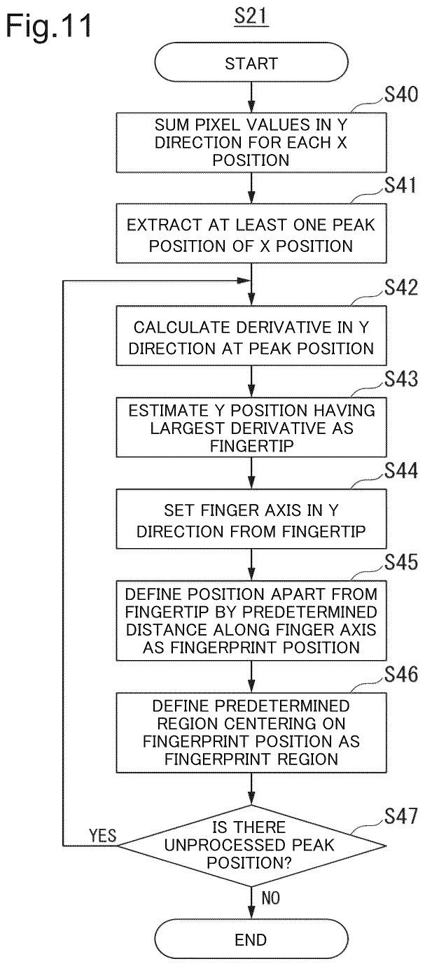

A case where the determination unit 212 divides the Nail to Nail region into six and determines six fingerprint regions is described with reference to FIG. 9, but the number of divisions is not limited to six. For example, as illustrated in FIG. 10, the determination unit 212 may divide the Nail to Nail region into four and determine four fingerprint regions. The determination unit 212 may divide the optical coherence tomography image into a freely selected number according to a desired size of the optical coherence tomography image and determine fingerprint regions of the freely selected number.

Although the optical coherence tomography image generation apparatus 3 captures an optical coherence tomography image of the fingerprint image of one finger among the fingers of the hand, the optical coherence tomography image generation apparatus 3 may capture optical coherence tomography images of a plurality of fingers among the fingers of the hand. For example, the optical coherence tomography image generation apparatus 3 may capture optical coherence tomography images of all fingers from the first finger to the fifth finger. Here, for example, the determination unit 212 may determine a plurality of fingerprint regions by dividing the fingerprint region of the first finger while not dividing the fingerprint regions of the second finger to the fifth finger.

In some example embodiments of the present disclosure, a case where the target is a hand is described as an example, but the target is not limited to the hand. The optical coherence tomography image generation apparatus 3 can also be applied to a target other than the hand as to be described later in another example embodiment.

### [3-3: Technical Effect of Optical Coherence Tomography Image Generation Apparatus 3]

The optical coherence tomography image generation apparatus 3 can acquire an optical coherence tomography image of a desired region even when the desired region of which an optical coherence tomography image is desired to be acquired is larger than a region that can be obtained by one optical coherence tomography. The optical coherence tomography image generation apparatus 3 also performs control of moving the position of the irradiation unit from the reference position of the first scan region to the reference position of the second scan region on which scanning is to be performed next while the scanning of the first scan region on which scanning is to be performed in advance among the scan regions is being performed. As a result, the optical coherence tomography image generation apparatus 3 can scan two or more regions freely set in the target and generate an image at a higher speed.

A scan control device, a scan control method, and a program according to some example embodiments of the present disclosure will be described. Hereinafter, the description will be given with reference to the scan control device, the scan control method, and an optical coherence tomography image generation apparatus 4 to which a program according to some example embodiments of the present disclosure is applied.

The optical coherence tomography image generation apparatus 4 differs from the optical coherence tomography image generation apparatus 2 and the optical coherence tomography image generation apparatus 3 in the determination operation by the determination unit 212. Other features of the optical coherence tomography image generation apparatus 4 may be the same as other features of at least one of the optical coherence tomography image generation apparatus 2 and the optical coherence tomography image generation apparatus 3.

### [4-1: Fingerprint Region Determination Operation by Optical Coherence Tomography Image Generation Apparatus 4]

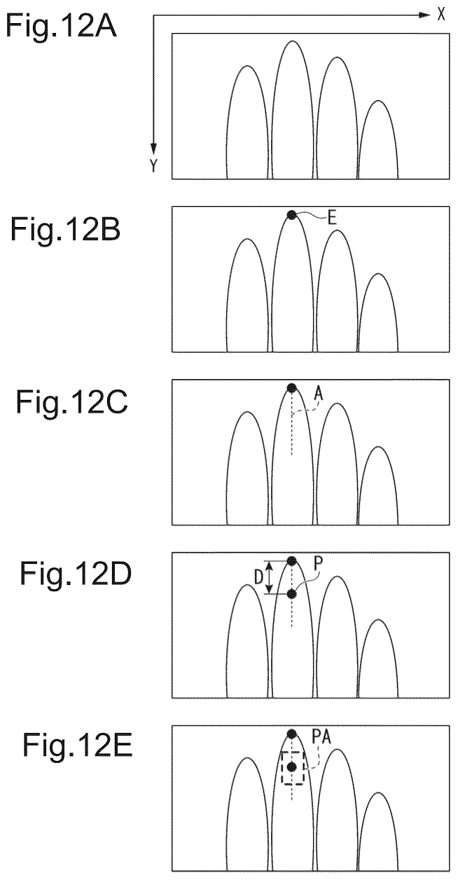

A flow of a fingerprint region determination operation performed by the optical coherence tomography image generation apparatus 4 will be described with reference to FIGS. 11 and 12. FIG. 11 is a flowchart illustrating a flow of the fingerprint region determination operation performed by the optical coherence tomography image generation apparatus 4. FIG. 12 is a conceptual diagram of the fingerprint region determination operation performed by the optical coherence tomography image generation apparatus 4.

In some example embodiments of the present disclosure, the target of the optical coherence tomography image generation is a hand. In some example embodiments of the present disclosure, the determination unit 212 determines the fingerprint region of at least one finger of the hand as at least one scanning region based on the stereoscopic image SI exemplified in part (a) of FIG. 12, for example. In some example embodiments of the present disclosure, the determination unit 212 may estimate a fingertip of at least one finger of the hand based on the stereoscopic image SI, estimate a finger axis, and determine a fingerprint region including a region apart from the fingertip by a predetermined distance along the finger axis as at least one of the plurality of scanning regions. The flowchart illustrated in FIG. 11 may indicate a detailed operation flow of the operation in step S21 in FIG. 4A.

As illustrated in FIG. 12, the determination unit 212 sums pixel values of pixels arranged in the Y direction for each X position in the X direction (step S40). The determination unit 212 may sum luminance values of the pixels arranged in the Y direction for each X position in the X direction. The X direction may be, for example, a horizontal direction (a width direction of the hand) in the case illustrated in FIG. 3B. Here, the Y direction may be a vertical direction (vertical direction along the axis of the finger) in the case illustrated in FIG. 3B. The optical coherence tomography image generation apparatus 4 may guide a direction of the finger to be held above the camera unit 110 such that a longitudinal direction of the finger is the Y direction. When the direction of the finger to be held above the camera unit 110 is determined, one direction in the stereoscopic image SI may be estimated as the finger axis.

Alternatively, the X direction may coincide with a movement direction of the light irradiation position (also referred to as “scanning line direction” and “fast axis direction of scanning”) by the irradiation unit 210 in the B scan described above. The Y direction may be a direction perpendicular to the X direction, and may coincide with the above-described “slow axis direction of scanning”.

The determination unit 212 extracts a peak of a sum of the pixel values of the pixels arranged in the Y direction at least at one X position (step S41). The determination unit 212 may detect peaks of a number equal to the number of fingers included in the stereoscopic image SI. The X position in which a fingertip portion exists is often the peak of the sum of the pixel values of the pixels arranged in the Y direction. Therefore, the determination unit 212 may estimate the X position of the peak of the sum of the pixel values of the pixels arranged in the Y direction as the X position at which the fingertip portion exists.

The determination unit 212 calculates a derivative in the Y direction at the X position of the peak of 1 (step S42). The determination unit 212 estimates a Y position in the Y direction indicating a limiting value of the derivative calculated in step S42 as the fingertip (step S43). The determination unit 212 may obtain a change in the pixel value in the Y direction and estimate that the fingertip exists at the Y position at which a change is large.

That is, the determination unit 212 may estimate a portion at which a change in position in a lateral direction of at least one finger of the hand is large and a change in position in a longitudinal direction of the finger is large as the fingertip based on the stereoscopic image SI. For example, as illustrated in part (b) of FIG. 12, the determination unit 212 may estimate a fingertip E.

The determination unit 212 sets a finger axis along the Y direction from the estimated fingertip (step S44). The determination unit 212 may estimate a longitudinal axis of the finger including a center of a portion having pixel values higher than the periphery as the finger axis of the finger based on the stereoscopic image SI. For example, as illustrated in part (c) of FIG. 12, the determination unit 212 may estimate a finger axis A.

The determination unit 212 defines a position apart from the estimated fingertip by a predetermined distance along the set finger axis as a fingerprint center position P (step S45). For example, as exemplified in part (d) of FIG. 12, the determination unit 212 may define a position apart from the fingertip E by a predetermined distance D as the fingerprint center position P. Instead of the predetermined distance D, the determination unit 212 may define a position apart from the fingertip E by a predetermined number of pixels as the fingerprint center position P.

The determination unit 212 defines a predetermined region centering on the fingerprint center position P as a fingerprint region PA (step S46). For example, as exemplified in part (e) of FIG. 12, the determination unit 212 may define a predetermined rectangular region centering on the fingerprint center position P as the fingerprint region PA. The determination unit 212 determines the fingerprint region PA including a region apart from the fingertip along the finger axis by a predetermined distance as at least one of the plurality of scanning regions.

The determination unit 212 determines whether there is an unprocessed peak position among the extracted peak positions (step S47). When there is an unprocessed peak position among the extracted peak positions (step S47: Yes), the process proceeds to step S42. When there is no unprocessed peak position among the extracted peak positions (step S47: No), the fingerprint region PA determination operation ends.

The determination unit 212 may calculate the fingertip E, the finger axis A, the fingerprint center position P, and the fingerprint region PA for each image configuring the stereoscopic image SI, and determine the three-dimensional position of the scanning region based on the fingertip E, the finger axis A, the fingerprint center position P, and the fingerprint region PA in each image.

### [4-2: Technical Effect of Optical Coherence Tomography Image Generation Apparatus 4]

The optical coherence tomography image generation apparatus 4 can easily and accurately determine the fingerprint region PA by estimating the fingertip and the finger axis. Since the optical coherence tomography image generation apparatus 4 estimates the fingertip according to the pixel value, the fingerprint region can be easily and accurately determined. Since the optical coherence tomography image generation apparatus 4 estimates the finger axis according to the pixel value, the fingerprint region can be easily and accurately determined. The method of determining the fingerprint region shown in some example embodiments of the present disclosure may be applied to determination of the fingerprint region in other example embodiments of the disclosure.

As described in each of the above example embodiments, the scan control unit 21 as one aspect of the scan control device (scanning control device) performs control of moving the position of the irradiation unit from the reference position of the first scan region to the reference position of the second scan region on which scanning is to be performed next while the scanning of the first scan region on which scanning is to be performed in advance is being performed. Hereinafter, details of the process of the scan control unit 21 will be described.

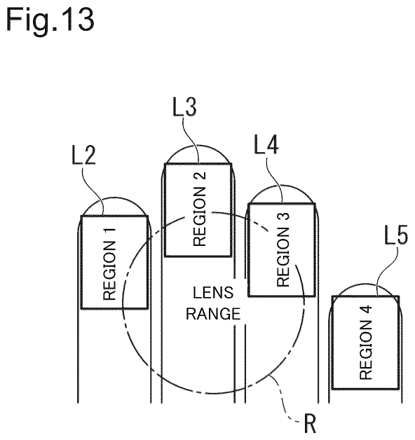

FIG. 13 illustrates a fingertip scan region determined in some example embodiments of the present disclosure. FIG. 13 illustrates a case where the scan control unit 21 determines each of (a) a fingerprint region L2 of the second finger, (b) a fingerprint region L3 of the third finger, (c) a fingerprint region L4 of the fourth finger, and (d) a fingerprint region L5 of the fifth finger of the left hand as the plurality of scanning regions (scan regions).

The scan control unit 21 controls a relative position of the lens position of the irradiation unit 210 with respect to the scanning target such that the fingerprint region L2, the fingerprint region L3, the fingerprint region L4, and the fingerprint region L5 are sequentially subjected to optical coherence tomography scanning (scan) by the irradiation unit 210. In some example embodiments of the present disclosure, the irradiation unit 210 provided in the scanner unit 200 has a function of a galvano scanner, and even when the position is fixed without moving relative to the scanning target, the laser light can be controlled in a freely selected direction using a reflecting mirror or the like and irradiated at a pinpoint such that the position in a predetermined range R can be freely scanned. The range is illustrated as a circular lens range R in FIG. 13. The lens range R may not be a circular range.

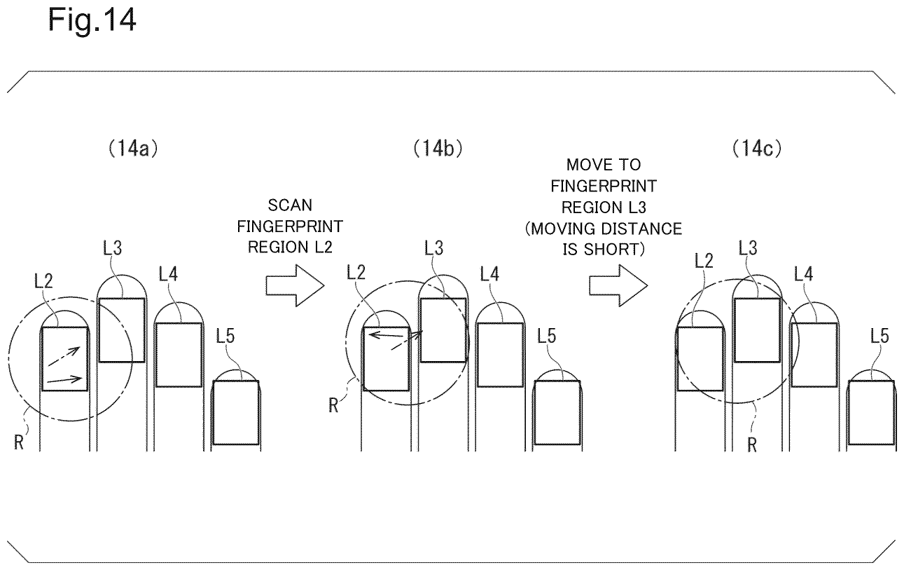

FIG. 14 is a first diagram illustrating an outline of position control of the irradiation unit.

When the fingerprint region L2 is the scanning target, the scan control unit 21 performs position control such that the lens range R includes at least a scanning position in the fingerprint region L2 at the start of scanning. While scanning the fingerprint region L2, the scan control unit 21 performs movement control such that the lens range R approaches the fingerprint region L3 that is a region to be scanned next (part (14a) of FIG. 14). Before finishing scanning of the fingerprint region L2, the scan control unit 21 performs movement control of the position of the lens range R in the direction of the fingerprint region L3 as the next scanning target (part (14b) in FIG. 14). As a result, since movement control of the lens range R in the direction of the scanning region as the next scanning target is performed during scanning of the scanning region as the previous scanning target, a time of waiting without moving the lens range R until scanning is completed in the scanning region as the current scanning target can be omitted, and a movement time can be shortened since a distance for moving the lens range R to the next scanning region can be shortened (part (14c) in FIG. 14).

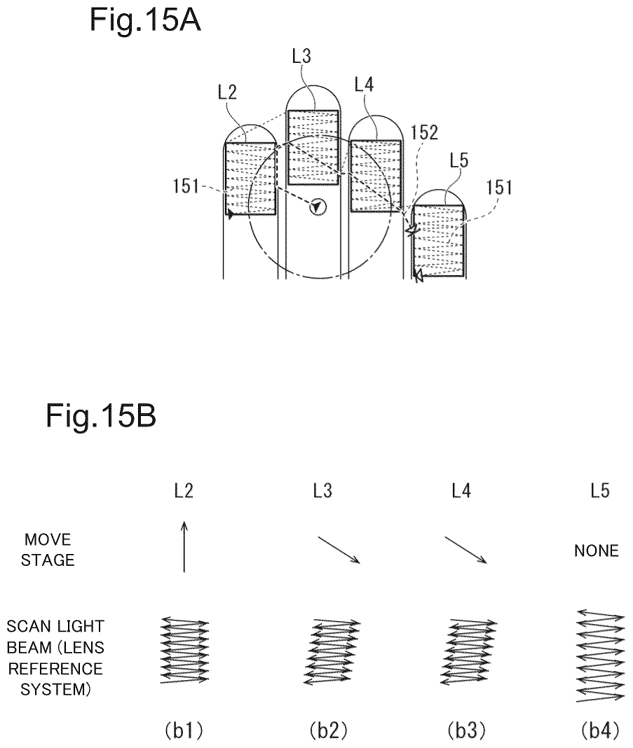

FIG. 15 is a diagram illustrating an outline of scanning control of the irradiation unit.

In scanning of each fingerprint region L using the irradiation unit 210, as indicated by a broken line in each fingerprint region L shown in part (15a) of FIG. 15, the scanner unit 200 scans in a direction from a first side to a second side (horizontal direction) on a left side or a right side in one of a lowermost part or an uppermost part of a rectangle of the fingerprint region L, then scans in a direction from the second side to the first side after controlling the irradiation position of the light beam by the irradiation unit 210 such that the scanning position relatively moves in a vertical direction in the region, and then scans in a direction from the first side to the second side after controlling the irradiation position of the light beam by the irradiation unit 210 such that the scanning position relatively moves in the vertical direction in the region, and repeats the scanning operation to scan inside the fingerprint region L. Such a scanning method is called raster scanning. In some example embodiments of the present disclosure, the irradiation unit 210 shifts the scanning line in the fingerprint region L by performing movement control of the irradiation position of the light beam by the irradiation unit 210 in the vertical direction of the rectangular fingerprint region (plane). The irradiation unit 210 performs scanning by irradiation with light in the horizontal direction. In some example embodiments of the present disclosure, a scanning speed of a plane in the horizontal direction per unit time of the irradiation unit 210 is faster than a scanning speed in the vertical direction. Therefore, the horizontal direction is referred to as a high-speed scanning axis, and the vertical direction is referred to as a low-speed scanning axis.

Here, as described above, when inside the fingerprint region L is scanned using the irradiation unit 210, the scanner unit 200 performs movement control of the stage 220 and moves the lens range R along a lens movement trajectory 152 in the direction of the scanning start position set for the next scanning region. Here, while moving the lens range R by performing movement control of the stage 220, the scanner unit 200 controls the irradiation unit 210 such that the actual light beam in a lens reference system is shifted in a direction of canceling a movement amount of the lens range R such that the scanning position coincides with a trajectory (broken line 151) of the scanning position by normal raster scanning of each fingerprint region L as illustrated in part (15a) in FIG. 15.

For example, when the fingerprint region L2 is scanned using the irradiation unit 210, the scanner unit 200 performs movement control of the stage 220 in a direction from an end on the finger base side (a lower part of the rectangle) to an end on the fingertip side (an upper part of the rectangle) (a vertical direction of the rectangular shape) of the fingerprint region L2, thereby controlling the lens range R to move relative to the fingerprint region L2 in the same direction. Here, when the scanner unit 200 scans the light beam using the irradiation unit 210, the movement direction of the lens range R and the direction in which the scanning lines are shifted from each other in raster scanning coincide with each other such that an interval between left and right scanning lines in the region is increased. Therefore, even when the lens range R is relatively moved with respect to the fingerprint region L2 by performing movement control of the stage 220 during scanning of the fingerprint region L2 using the irradiation unit 210, the scanner unit 200 performs scanning control of the light beam using the irradiation unit 210 not to widen the interval of the scanning lines in the horizontal direction and to narrow the interval of the scanning lines ((b1) of FIG. 15). Here, the scanner unit 200 performs scanning control using the irradiation unit 210 such that the movement amount and the movement direction per unit time of the light irradiation position in the scanning cancels the movement amount per unit time of the lens range R in the movement direction. As a result, the scanner unit 200 performs scanning control of the light beam using the irradiation unit 210 such that the scanning position in the scanning region when the lens range R is not moved during scanning of the scanning region and the scanning position in the scanning region when the lens range R is moved during scanning of the scanning region become the same position.

When scanning the fingerprint region L3 using the irradiation unit 210, the scanner unit 200 performs movement control of the lens range R in the direction of the scanning start position set for the fingerprint region L4 while scanning the fingerprint region L3. For example, when scanning the fingerprint region L3 using the irradiation unit 210, the scanner unit 200 performs movement control of the stage 220 such that the lens range R moves along the lens movement trajectory 152 from the left central portion of the rectangle of the fingerprint region L3 in the lower right direction. Here, when the scanner unit 200 scans the light beam by control of normal raster scanning using the irradiation unit 210, the movement direction in the vertical direction indicated by relative movement in the rectangle of the fingerprint region L3 of the lens range R and the movement direction in the vertical direction in which the scanning lines are shifted from each other coincide with each other as the downward direction and the lens range R moves in the lower right direction in the rectangle, such that the interval between the scanning lines in the horizontal direction of the rectangle of the fingerprint region L3 widens and a terminal position of one scanning line in the horizontal direction is shifted in the lower right direction that is the movement direction of the lens range R. Therefore, even when the lens range R is relatively moved with respect to the fingerprint region L3 based on movement control of the stage 220 during scanning of the fingerprint region L3, the scanner unit 200 performs scanning control of the light beam using the irradiation unit 210 not to widen the interval between the scanning lines and to narrow the interval between the scanning lines, and performs scanning control such that the terminal position of one scanning line in the horizontal direction is not shifted in the movement direction of the lens range R and the movement amount per unit time in the movement direction is canceled ((b2) in FIG. 15).

When scanning the fingerprint region L4 using the irradiation unit 210, the scanner unit 200 performs movement control of the lens range R in the direction of the scanning start position set for the fingerprint region L5. For example, when scanning the fingerprint region L4 using the irradiation unit 210, the scanner unit 200 controls the stage 220 to move in a direction from a left middle portion of the rectangle of the fingerprint region L4 to a right lower portion such that the lens range R also relatively moves in the same direction. Here, when the scanner unit 200 scans the light beam using the irradiation unit 210, the movement direction in the lens range R and the direction in which the scanning lines are shifted from each other coincide with each other as the downward direction and the lens range R moves in the lower right direction, such that the interval between the scanning lines in the horizontal direction of the rectangle of the fingerprint region widens and a terminal position of one scanning line in the horizontal direction is shifted in the lower right direction that is the movement direction of the lens range R. Therefore, even when the lens range R is relatively moved with respect to the fingerprint region L4 based on movement control of the stage 220 during scanning of the fingerprint region L4, the scanner unit 200 performs scanning control of the light beam using the irradiation unit 210 not to widen the interval between the scanning lines in the horizontal direction and to narrow the interval between the scanning lines, and performs control of setting a position at which movement in the movement direction is canceled as the terminal position of the scanning such that the terminal position of one scanning line in the horizontal direction is not shifted in the movement direction of the lens range R ((b3) in FIG. 15).

When scanning the fingerprint region L5 using the irradiation unit 210, the scanner unit 200 does not need to move the stage 220 when the entire region of the fingerprint region L5 is included in the lens range R. Here, the scanner unit 200 performs normal light beam scanning control using the irradiation unit 210 ((b4) in FIG. 15).

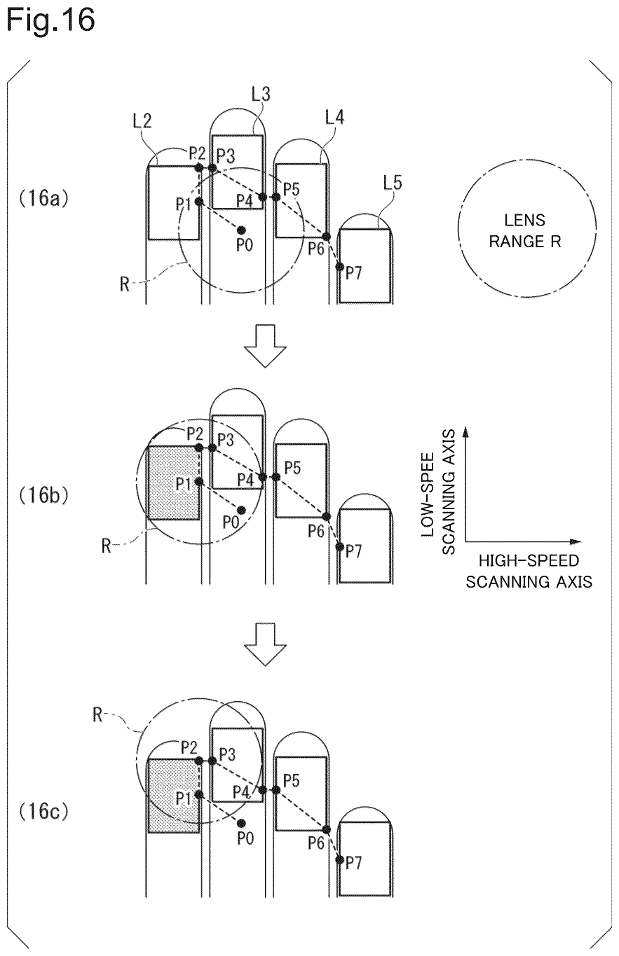

FIG. 16 is a first diagram illustrating an outline of scan control of the scan control device.

The scan control unit 21 as an aspect of the scan control device (scanning control device) generates scan control information and outputs the scan control information to the scanner unit 200 such that the scanner unit 200 can perform scanning control illustrated in FIGS. 14 and 15 using the irradiation unit 210 and the stage 220. Specifically, when determining the fingerprint regions L1, L2, L3, and L4 by the process described in the above-described other example embodiments, the scan control unit 21 calculates a start position to which the reference position as a center of the lens range R is first matched and a final position to which the reference position is last matched in each fingerprint region L based on information on a position of the fingerprint region L in the coordinate system of image processing and scan control processing, a reference position P0 of the lens range R, and a radius and a diameter of the lens range R. In the present disclosure, the reference position P0 of the lens range R indicates a center of the irradiation range (circular lens range R) of the light beam with which the target is irradiated from the lens provided in the irradiation unit 210, and the reference position P0 in FIG. 16 indicates a current position of the center of the irradiation range. The start position and the final position in each fingerprint region L are examples of scan control information. The scan control information may include at least the position of each fingerprint region L and the start position. The scan control information may include other types of information.

As an example, for the fingerprint region L2, the scan control unit 21 calculates a center of the right side of the rectangular shape of the region as a start position P1 and an upper right vertex of the rectangular shape of the region as a final position P2. The start position P1 may be a position including the scanning start position in the fingerprint region L2 at least in the lens range R. By setting a position including the scanning start position in the fingerprint region L2 at least in the lens range R as the start position P1, the stage 220 is controlled to align the reference position P0 of the lens range R with the start position P1, such that operation can be immediately performed from the scanning start position. The start position P1 may be a position at which the entire fingerprint region L2 is included in the lens range R and the reference position of the lens range R and the right side of the rectangular shape of the fingerprint region L2 coincide with each other. The final position P2 may be a position of a side of the rectangular region of the fingerprint region L2 closest to a start position P3 of the fingerprint region L3 that is the next scanning region.

For the fingerprint region L3, the scan control unit 21 calculates the start position P3 set to the upper left side of the rectangular shape of the region and a final position P4 set to the lower right side of the rectangular shape of the region. The start position P3 may be a position including the scanning start position in the fingerprint region L3 at least in the lens range R. The start position P3 may be a position at which the entire fingerprint region L3 is included in the lens range R and the reference position of the lens range R and the left side of the rectangular shape of the fingerprint region L3 coincide with each other. The final position P4 may be a position of a side of the rectangular region of the fingerprint region L3 closest to a start position P5 of the fingerprint region L4 that is the next scanning region.

For the fingerprint region L4, the scan control unit 21 calculates the start position P5 set to the upper left side of the rectangular shape of the region and a final position P6 set to the upper right side of the rectangular shape of the region. The start position P5 may be a position including the scanning start position in the fingerprint region L4 at least in the lens range R. The start position P5 may be a position at which the entire fingerprint region L4 is included in the lens range R and the reference position of the lens range R and the left side of the rectangular shape of the fingerprint region L4 coincide with each other. The final position P6 may be a vertex at which the right side and the lower side of the rectangular region of the fingerprint region L4 closest to a start position P7 of the fingerprint region L5 that is the next scanning region intersect.

For the fingerprint region L5, the scan control unit 21 calculates the start position P7 set to the upper left side of the rectangular shape of the region. The start position P7 may be a position including the scanning start position in the fingerprint region L5 at least in the lens range R. The start position P7 may be a position at which the entire fingerprint region L5 is included in the lens range R and the reference position of the lens range R and the left side of the rectangular shape of the fingerprint region L5 coincide with each other. The control unit 213 does not need to calculate a final position when the fingerprint region L5 that is the scanning region to be scanned last falls within a range of the lens range R when the reference position P0 of the lens range R is aligned with the start position P7.

The scanner unit 200 acquires information on the scanning start position and the scanning final position calculated as described above and scan control information including the position of each fingerprint region from the scan control unit 21 and starts operation. When scanning the fingerprint region L5 using the irradiation unit 210, the scanner unit 200 does not need to perform movement control of the relative position of the lens range R with respect to the fingerprint region L5 during scanning of the fingerprint region L5 since there is no scanning region to be subjected to scanning control next to the fingerprint region L5.

For a certain fingerprint region L, when the reference position P0 of the lens range R is aligned with the start position and the fingerprint region L does not fall within the range of the lens range R, the scanner unit 200 performs movement control of the stage 220 of moving the relative position of the lens range R with respect to the certain fingerprint region L during scanning of the fingerprint region L and controlling the position such that the position is included in the lens range R at a timing when the light beam irradiates the last scanning end position in the fingerprint region L. For example, when the reference position P0 of the lens range R is immediately above the third finger at a timing before scanning the fingerprint region L2 (part (16a) in FIG. 16), the scan control unit 21 sets the start position P1 on a side of the rectangular shape of the fingerprint region L2 closest to the reference position P0 of the lens range R. Then, the scanner unit 200 performs movement control of the stage 220 to which the irradiation unit 210 is fixed until a perpendicular line passing through the start position P1 coincides with a perpendicular line passing through the reference position P0 of the lens range R, and after aligning the reference position P0 with the start position P1, starts scanning of the fingerprint region L2 using the irradiation unit 210 (part (16b) in FIG. 16). When the scanner unit 200 moves the lens range R by performing movement control of the stage 220 to a position at which the perpendicular line passing through the reference position P0 coincides with a perpendicular line passing through the final position P2, the scanner unit performs movement control of the stage 220 such that the perpendicular line passing through the reference position P0 of the lens range R coincides with a perpendicular line passing through the start position P3 of the fingerprint region L3 that is the next scanning region. After scanning of the fingerprint region L2 using the irradiation unit 210 is completed, the scanner unit 200 performs movement control of the stage 220 such that the reference position P0 of the lens range R moves from the final position P2 of the fingerprint region L2 being scanned in advance to the start position P3 of the fingerprint region L3 to be scanned next. Since the final position P2 is closer to the start position P3 of the scanning region L3 to be scanned next than the start position P1, a moving time of the irradiation unit 210 to the next scanning region after scanning of the scanning region to be scanned in advance is completed can be shortened by such a method. Alternatively, before scanning of the fingerprint region L2 using the irradiation unit 210 is completed, the scanner unit 200 may perform movement control of the stage 220 such that the reference position P0 of the lens range R moves from the final position P2 of the fingerprint region L2 being scanned in advance to the start position P3 of the fingerprint region L3 to be scanned next. As a result, it is possible to shorten a time from start of scanning of the fingerprint region L2 as the scanning region to be scanned first among the plurality of scanning regions until end of scanning of the fingerprint region L5 as the scanning region to be scanned last. Such a process is one aspect of a process in which the scanner unit 200 performs movement control of the stage 220 while scanning the first scanning region to be scanned in advance using the irradiation unit 210, performs movement control of the reference position from the start position set for the first scanning region to the second start position set for the second scanning region to be scanned next, and performs movement control of the reference position to the second start position before scanning of the first scanning region is completed.

It is assumed that the scanner unit 200 moves the stage 220 to move the reference position P0 of the lens range R from the final position of the scanning region to be scanned in advance among the scanning regions to be sequentially scanned to the start position of the scanning region to be scanned next before scanning of the scanning region to be scanned in advance is completed. Here, the movement direction of the stage 220, that is, the movement direction of the lens range R changes during scanning of the scanning region to be scanned in advance. For example, in a case of scanning the fingerprint region L2, the scanner unit 200 performs raster scanning on the fingerprint region L2 using the irradiation unit 210 while performing movement control of the stage 220 in the direction of (b1) as illustrated in the portion (15b) in FIG. 15, and performs movement control of the stage 220 in the direction of (b2) in the portion (15b) in FIG. 15 before raster scanning of the fingerprint region L2 ends, thereby changing the movement direction of the stage 220. Even when there is such a change in the movement direction of the lens range R, the scanner unit 200 performs irradiation control of the irradiation direction of light in scanning of the irradiation unit 210 in a direction of canceling the movement amount according to the change of the movement direction of the stage 220 (movement direction of the lens range R). As a result, the scanner unit 200 performs scanning control of the light beam such that the scanning position in the scanning region according to elapsed time becomes the same position when the scanning region is scanned using the irradiation unit 210 without performing movement control of the stage 220 (movement control of the lens range R) and when the scanning region is scanned using the irradiation unit 210 while performing movement control of the stage 220 (movement control of the lens range R).

Next, an optical coherence tomography image generation apparatus according to some example embodiments of the present disclosure will be described.

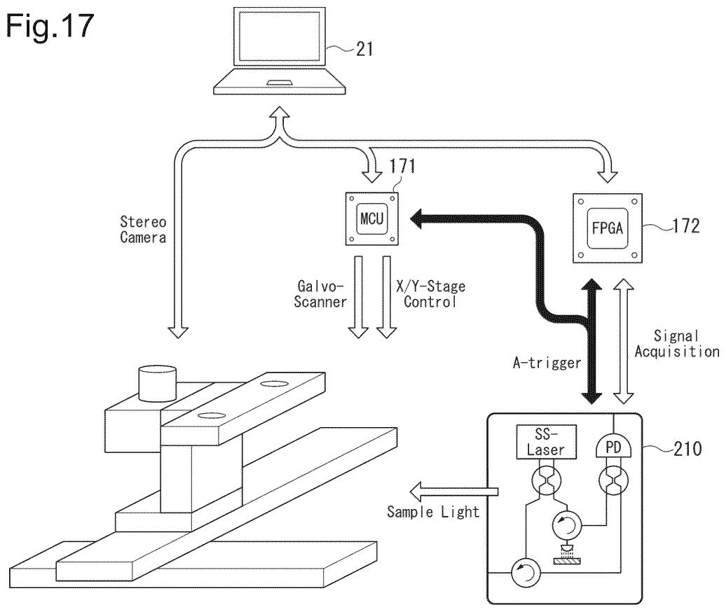

FIG. 17 is a first diagram illustrating a hardware configuration of the optical coherence tomography image generation apparatus.

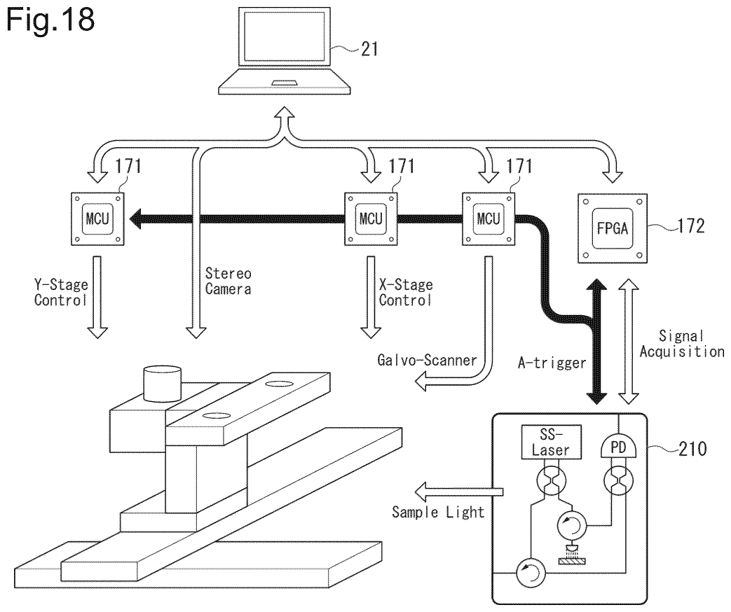

FIG. 18 is a second diagram illustrating a hardware configuration of the optical coherence tomography image generation apparatus.

As illustrated in FIG. 17, the scanner unit 200 may include a first control unit 171 including a micro controller unit (MCU) and a second control unit 172 including a field programmable gate array (FPGA). The first control unit 171 acquires scan control information from the scan control unit 21, and performs scanning control using the irradiation unit 210 in the scanner unit 200 and movement control of the position of the lens range R using the stage 220. The second control unit 172 performs a process such as generation of an optical coherence tomography image of a target in the scanner unit 200. At least one of the first control unit 171 and the second control unit 172 may be provided in the scan control unit 21. Here, the control unit 213 may perform the process of at least one of the first control unit 171 and the second control unit 172.

As illustrated in FIG. 18, the scanner unit 200 may include a plurality of first control units 171 including MCU, and the plurality of (three) first control units 171 may separately perform each process of movement control of the stage 220 in the X direction as one of the X direction and the Y direction orthogonal to each other on a secondary plane, movement control of the stage 220 in the Y direction, and scanning control using the irradiation unit 210. Also in FIG. 18, at least one of a plurality of the first control units 171 and the second control unit 172 may be provided in the scan control unit 21. Here, the control unit 213 may perform the process of at least one of the plurality of first control units 171 and the second control units 172.

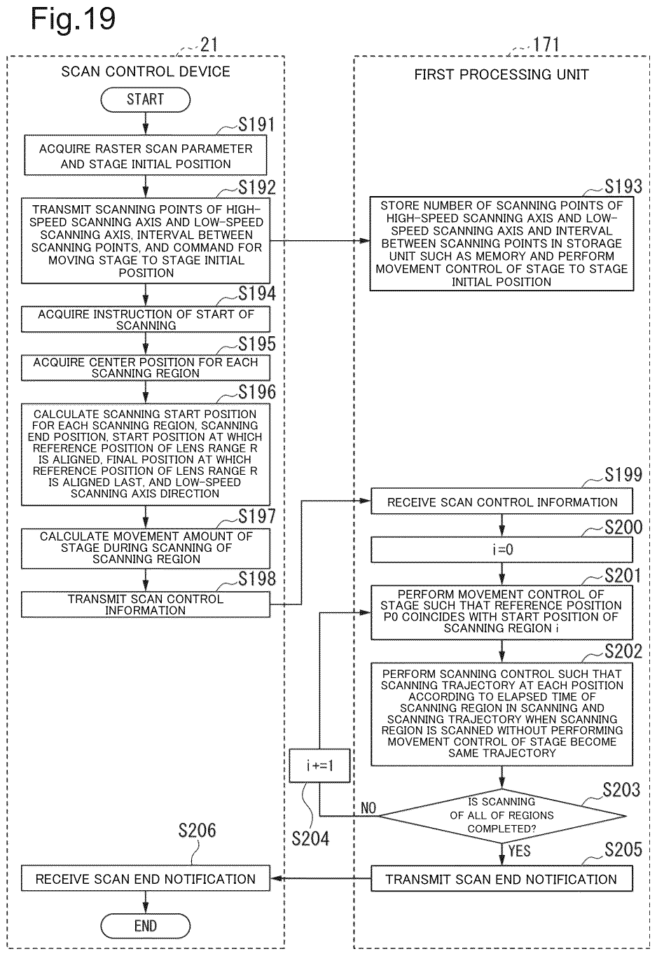

FIG. 19 is a diagram illustrating a processing flow of the scan control device and the first control unit.

First, the control unit 213 of the scan control unit 21 as an aspect of the scan control device (scanning control device) acquires raster scan parameters (position, range, and resolution of scanning region) and a stage initial position in the coordinate system of the stage 220 based on information stored in a user interface system or by initial setting (step S191). The control unit 213 calculates the number of scanning points and the interval between the scanning points on the high-speed scanning axis (the horizontal direction of the scanning plane) and the low-speed scanning axis (the vertical direction of the scanning plane), and transmits the calculated results to the first control unit 171. The control unit 213 transmits a command for moving the stage 220 to the stage initial position to the first control unit 171 (step S192). The first control unit 171 stores the number of scanning points and the interval between the scanning points of the high-speed scanning axis and the low-speed scanning axis in a storage unit such as a memory, and performs movement control of the stage 220 to the stage initial position (step S193).

Then, the control unit 213 acquires an instruction to start scanning the plurality of scanning regions from a user interface or the like (step S194). The center position is acquired for each of the already specified scanning regions (step S195). The control unit 213 calculates a scanning start position, a scanning end position, a start position at which a reference position of the lens range R is aligned at the start of scanning, a final position at which the reference position of the lens range R in the scanning region is aligned last, and a low-speed scanning axis direction of the irradiation unit 210 (galvano scanner) for each scanning region (step S196). For example, in the fingerprint region L2 as the scanning region, the scanning start position is a lower left vertex of the rectangular shape of the fingerprint region L2 (refer to FIG. 15), and a scanning end position is an upper left vertex of the rectangular shape of the fingerprint region L2 (refer to FIG. 15). In the fingerprint region L2 as the scanning region, the start position at which the reference position P0 of the lens range R of the irradiation unit 210 (galvano scanner) is aligned at the start of scanning is P1 (refer to FIG. 16), and the final position at which the reference position P0 of the lens range R of the irradiation unit 210 (galvano scanner) is aligned at the end of scanning is P2 (refer to FIG. 16).

The control unit 213 calculates a movement amount of the stage 220 during scanning of the scanning region by the irradiation unit 210 based on a difference between the start position at which the reference position P0 of the lens range R of the irradiation unit 210 (galvano scanner) is aligned at the start of scanning and the final position at which the reference position P0 of the lens range R of the irradiation unit 210 (galvano scanner) is aligned at the end of scanning (step S197). The control unit 213 generates scan control information including the start position for aligning the reference position P0 of the lens range R at the start of scanning in each scanning region, the scanning start position in each scanning region by the irradiation unit 210 (galvano scanner), the movement direction of the stage 220 in each scanning region and the movement amount of the stage 220, the scanning direction of the low-speed scanning axis of the irradiation unit 210 (galvano scanner), and the like, and transmits the scan control information to the first control unit 171 (step S198). The scan control information may include a final position at which the reference position P0 of the lens range R is aligned last in each scanning region, and an end position of scanning by the irradiation unit 210 (galvano scanner) in each scanning region.

The first control unit 171 receives the scan control information (step S199). The first control unit 171 sets i=0 to scan the first scanning region i=0 among the plurality of scanning regions (i=N) (step S200). The first control unit 171 performs movement control of the stage 220 such that the reference position P0 of the lens range R coincides with the start position for aligning the reference position P0 at the start of scanning of the scanning region i (step S201). The first control unit 171 performs raster scanning of the light beam of the irradiation unit 210 to scan from the scanning start position of the scanning region i, and performs movement control of the stage 220 sequentially based on the unit movement amount of the stage 220 during the scanning. Here, the first control unit 171 performs irradiation control of the light irradiation direction in the scanning by the irradiation unit 210 in a direction of canceling the movement amount in the movement direction of the stage 220, and performs scanning control such that the scanning trajectory at each position according to elapsed time of the scanning region in the scanning and the scanning trajectory when the scanning region is scanned without performing movement control of the stage 220 become the same trajectory (step S202).

The first control unit 171 determines whether scanning of all of the plurality of (N) scanning regions i is completed (step S203). When scanning of all of the plurality of (N) scanning regions i is not completed, the first control unit 171 adds 1 to the set value of i (step S204), and repeats the process from step S201. When i=N, it is determined that scanning of all of the plurality of (N) scanning regions i is completed, and a scan end notification is transmitted to the scan control unit 21 (step S205). When receiving the scan end notification (step S206), the scan control unit 21 ends the process.

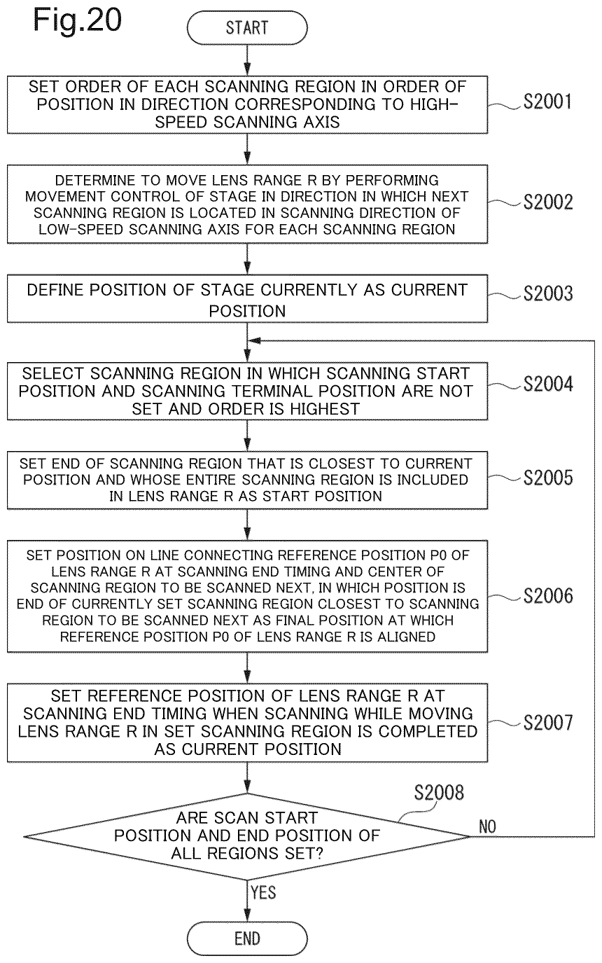

FIG. 20 is a diagram illustrating a processing flow of the scan control device.

Details of the process in step S196 described above will be described. The control unit 213 as one aspect of the scan control device (scanning control device) sets the order of each scanning region (fingerprint region L) in the order of the position in a direction according to the high-speed scanning axis (plane horizontal direction) (step S2001). For each scanning region, the control unit 213 determines to move the lens range R by performing movement control of the stage 220 in the direction in which the next scanning region is located in the scanning direction of the low-speed scanning axis (plane vertical direction) for each scanning region (step S2002). For example, when the fingerprint region L2 is scanned, movement control of the stage 220 is determined to be performed in a direction (upward direction) in which the fingerprint region L2 to be scanned next is located in the vertical direction. The control unit 213 defines a position of the stage 220 currently as a current position (step S2003). The control unit 213 selects the scanning region in which the scanning start position and the scanning end position are not set and the order is highest (step S2004). The control unit 213 sets an end of the scanning region that is closest to the current position and whose entire scanning region is included in the lens range R as a start position (P1 in the case of fingerprint region L2) for aligning the reference position of the lens range R (step S2005). The control unit 213 may set a start position for aligning the reference position of the lens range R such that at least the scanning start position of the selected scanning region is included in the lens range R.

The control unit 213 sets a position on a line connecting reference position P0 of the lens range R at the scanning end timing when scanning is completed while moving the lens range R in the set scanning region using the irradiation unit 210 and a center of the scanning region to be scanned next as a final position (P2 in the case of fingerprint region L2), the final position being a position of an end of the currently set scanning region closest to the next scanning target scanning region (step S2006). The control unit 213 sets the reference position of the lens range R at the scanning end timing when scanning while moving the lens range R in the set scanning region is completed as the current position (step S2007). The control unit 213 determines whether the process is completed for all the scanning regions (step S2008). When the process is not completed for all the scanning regions, the control unit 213 repeats the process from step S2004.

The control unit 213 calculates the scanning start position and the scanning end position in each region. For example, a vertex in the rectangular shape of the scanning region closest to the set current position may be set as the scanning start position, and a position at which raster scanning of the scanning region performed from the start position is completed may be set as the scanning end position. As a result, the control unit 213 ends the process of step S196.

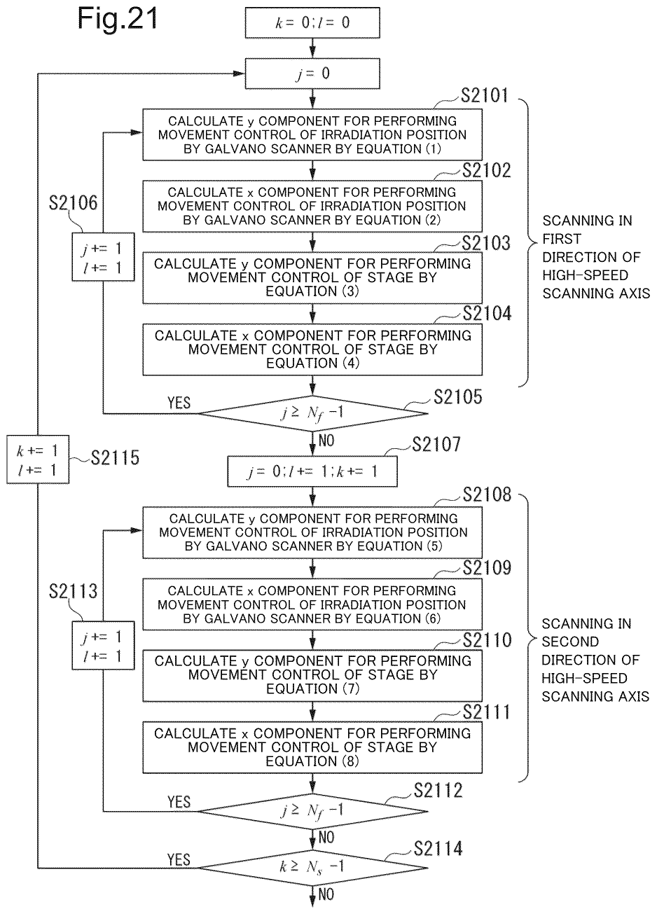

FIG. 21 is a diagram illustrating a processing flow of the first control unit.

Next, details of the process in step S202 will be described with reference to FIG. 21.

First, in some example embodiments of the present disclosure, the first control unit 171 controls the irradiation unit 210 to perform raster scanning in the scanning region.

The numbers of dots (points) configuring the trajectory of the scanning line in the current scanning region in the x-axis direction and the y-axis direction are each represented by Nf and Ns. An x component and a y component of an interval (distance) for each dot configuring the trajectory of the scanning line are each represented by tf and ts.

A variable of the scanning line in the scanning region is represented by k, a variable of a point of the dots configuring the scanning trajectory (refer to broken line 151 in FIG. 15) in the scanning region is represented by l (el), and a variable of a point of dots in one scanning line is represented by j. An x component and a y component at the scanning start position of the irradiation unit 210 (galvano scanner) are each represented by Sf and Ss. An x component and a y component of the movement amount for each dot that may configure the scanning line by the irradiation unit 210 (galvano scanner) are each represented by df and ds.

The first control unit 171 sets k=0, l=0, and j=0 as initial values.

The first control unit 171 calculates a y component (ygalvo) and an x component (xgalvo) for performing movement control of the irradiation position of object light output from the irradiation unit 210 (galvano scanner) with respect to the target by Equations (1) and (2) (Step S2101, Step S2102). The first control unit 171 calculates a y component (ystage) and an x component (xstage) for performing movement control of the stage 220 by Equations (3) and (4) (Step S2103, Step S2104). The first control unit 171 performs movement control of the irradiation position of object light output from the irradiation unit 210 (galvano scanner) with respect to the target according to a galvano scanner control command including the y component (ygalvo) and the x component (xgalvo) for performing movement control of the irradiation position by the irradiation unit 210. The first control unit 171 performs movement control of the stage 220 according to a stage control command including the y component (ystage) and the x component (xstage) for performing movement control of the stage 220.

$$\begin{matrix}[ Equation 1 ] & \\ {y}_{galvo} = {S}_{s} \pm k * {t}_{s} - \frac{{d}_{s}}{( {N}_{s} * {N}_{f} - 1 )} * l & ( 1 )\end{matrix}$$

$$\begin{matrix}[ Equation 2 ] & \\ {x}_{galvo} = {S}_{f} + j * {t}_{f} - \frac{{d}_{s}}{( {N}_{s} * {N}_{f} - 1 )} * l & ( 2 )\end{matrix}$$

$$\begin{matrix}[ Equation 3 ] & \\ {y}_{stage} + \frac{{d}_{s}}{( {N}_{s} * {N}_{f} - 1 )} * l & ( 3 )\end{matrix}$$

$$\begin{matrix}[ Equation 4 ] & \\ {x}_{stage} + \frac{{d}_{f}}{( {N}_{s} * {N}_{f} - 1 )} * l & ( 4 )\end{matrix}$$

The processes of steps S2101 to S2104 are processing in a case of scanning in the first direction (from left to right in the plane) in the high-speed scanning axis direction of raster scanning (scanning in first direction of the high-speed scanning axis). In Equations (1) and (2), “±” indicates “+” when movement in the low-speed scanning axis direction (plane vertical direction) is from below to above, and “−” when the movement is from above to below.

As shown in Equations (1) to (4), in movement control of the irradiation position of object light output from the irradiation unit 210 (galvano scanner) with respect to the target, a value of the movement amount in the movement control of the stage 220 is subtracted. As a result, the first control unit 171 performs irradiation control of the light irradiation direction in scanning by the irradiation unit 210 in a direction of canceling the movement amount in the movement direction of the stage 220, and performs scanning control by which the position of the scanning trajectory in the scanning region being scanned and the position of the scanning trajectory when assuming that the scanning region is scanned without performing movement control of the lens position of the irradiation unit 210 (galvano scanner) are at the same position. As a result, even when movement control of the lens position by the stage 220 is performed while the scanning region is scanned by the irradiation unit 210, the scanning region can be scanned with the same scanning trajectory as a case where movement control by the stage 220 is not performed.

The first control unit 171 determines whether the number (Nf−1) obtained by subtracting 1 from the number Nf of scanning points in the high-speed scanning axis direction currently being calculated is equal to or less than a number j that is an upper limit of points included in the trajectory of one scanning line in the high-speed scanning axis direction (step S2105). When the number (Nf−1) obtained by subtracting 1 from the number Nf of scanning points in the high-speed scanning axis direction currently being calculated is equal to or less than the number j that is an upper limit of points included in the trajectory of the scanning line in one high-speed scanning axis direction (Step S2105: Yes), the first control unit 171 adds 1 to the variables “j” and “i” (Step S2106), and repeats the processes of Step S2101 to Step S2105.

When the number (Nf−1) obtained by subtracting 1 from the number Nf of scanning points in the high-speed scanning axis direction currently being calculated is not equal to or less than the number j that is an upper limit of points included in the trajectory of one scanning line in the high-speed scanning axis direction (Step S2105: No), the first control unit 171 ends the process for one scanning line and proceeds to the process for the next scanning line. That is, the first control unit 171 sets 0 to the variable of “j” and adds 1 to the variables of “i” and “k” (step S2107).

The first control unit 171 calculates the y component (ygalvo) and the x component (xgalvo) for performing movement control of the irradiation position of object light output from the irradiation unit 210 (galvano scanner) with respect to the target by Equations (5) and (6) (Step S2108, Step S2109). The first control unit 171 calculates the y component (ystage) and the x component (xstage) for performing movement control of the stage 220 by Equations (7) and (8) (Step S2110, Step S2111).

The first control unit 171 performs movement control of the irradiation position of object light output from the irradiation unit 210 (galvano scanner) with respect to the target according to a galvano scanner control command including the y component (ygalvo) and the x component (xgalvo) for performing movement control of the irradiation position by the irradiation unit 210. The first control unit 171 performs movement control of the stage 220 according to a stage control command including the y component (ystage) and the x component (xstage) for performing movement control of the stage 220.

$$\begin{matrix}[ Equation 5 ] & \\ {y}_{galvo} = {S}_{s} \pm k * {t}_{s} - \frac{{d}_{s}}{( {N}_{s} * {N}_{f} - 1 )} * l & ( 5 )\end{matrix}$$

$$\begin{matrix}[ Equation 6 ] & \\ {x}_{galvo} = {S}_{f} + ( {N}_{f} - 1 ) * {t}_{f} - j * {t}_{f} - \frac{{d}_{s}}{( {N}_{s} * {N}_{f} - 1 )} * l & ( 6 )\end{matrix}$$

$$\begin{matrix}[ Equation 7 ] & \\ {y}_{stage} + \frac{{d}_{s}}{( {N}_{s} * {N}_{f} - 1 )} * l & ( 7 )\end{matrix}$$

$$\begin{matrix}[ Equation 8 ] & \\ {x}_{stage} + \frac{{d}_{f}}{( {N}_{s} * {N}_{f} - 1 )} * l & ( 8 )\end{matrix}$$

The processes of steps S2108 to S2111 are processing in a case of scanning in the second direction (from right to left in the plane) in the high-speed scanning axis direction of raster scanning (scanning in second direction of the high-speed scanning axis). In Equations (5) and (6), “±” indicates “+” when movement in the low-speed scanning axis direction (plane vertical direction) is from below to above, and “−” when the movement is from above to below.

As shown in Equations (5) to (8), in movement control of the irradiation position of object light output from the irradiation unit 210 (galvano scanner) with respect to the target, the value of the movement amount in the movement control of the stage 220 is subtracted. As a result, the first control unit 171 performs irradiation control of the light irradiation direction in scanning by the irradiation unit 210 in a direction of canceling the movement amount in the movement direction of the stage 220, and performs scanning control by which the position of the scanning trajectory in the scanning region being scanned and the position of the scanning trajectory when assuming that the scanning region is scanned without performing movement control of the lens position of the irradiation unit 210 (galvano scanner) are at the same position. As a result, even when movement control of the lens position by the stage 220 is performed while the scanning region is scanned by the irradiation unit 210, the scanning region can be scanned with the same scanning trajectory as the case where movement control by the stage 220 is not performed.

The first control unit 171 determines whether the number (Nf−1) obtained by subtracting 1 from the number Nf of scanning points in the high-speed scanning axis direction currently being calculated is equal to or less than a number j that is an upper limit of points included in the trajectory of one scanning line in the high-speed scanning axis direction (step S2112). When the number (Nf−1) obtained by subtracting 1 from the number Nf of scanning points in the high-speed scanning axis direction currently being calculated is equal to or less than the number j that is an upper limit of points included in the trajectory of the scanning line in one high-speed scanning axis direction (Step S2112: Yes), the first control unit 171 adds 1 to the variables “j” and “i” (Step S2113), and repeats the processes of Step S2108 to Step S2112.

When the number (Nf−1) obtained by subtracting 1 from the number Nf of scanning points in the high-speed scanning axis direction currently being calculated is not equal to or less than the number j that is an upper limit of points included in the trajectory of one scanning line in the high-speed scanning axis direction (Step S2112: No), the first control unit 171 ends the process for one scanning line.

The first control unit 171 determines whether the number (Ns−1) obtained by subtracting 1 from the number Ns of scanning points in the low-speed scanning axis direction currently being calculated is equal to or less than the number k that is an upper limit of scanning lines included in one scanning region (step S2114). When the number (Ns−1) obtained by subtracting 1 from the number Ns of scanning points in the low-speed scanning axis direction currently being calculated is equal to or less than the number k that is an upper limit of scanning lines included in one scanning region, the first control unit 171 adds 1 to the variables “k” and “1” (step S2113), sets 0 to “j”, and repeats the process from step S2101. When the number (Ns−1) obtained by subtracting 1 from the number Ns of scanning points in the low-speed scanning axis direction currently being calculated is not equal to or less than the number k that is an upper limit of scanning lines included in one scanning region, the first control unit 171 proceeds to the process of step S197.

The process according to some example embodiments of the present disclosure described above is one aspect of the process in which the acquisition unit 211 of the scan control unit 21 acquires information on at least two scanning regions in a scanning target and a reference position used for specifying a position of the irradiation unit 210 provided in the scanner unit 200 that irradiates the scanning regions with scanning light, and the first control unit 171 performs control of moving the position of the irradiation unit 210 from a start position at which the reference position is first aligned in a region set in the first scanning region to a start position at which the reference position is first aligned in a second scanning region to be scanned next while the first scanning region to be scanned in advance among the scanning regions is being scanned. The process of the first control unit 171 may be performed by the control unit 213 of the scan control unit 21. By the process of the first control unit 171 or the control unit 213, the lens position is subjected to movement control in the direction of the next scanning target scanning region by performing movement control of the stage 220 during the scanning of the scanning region using the irradiation unit 210, and thus a standby time until scanning of the scanning region to be scanned in advance is completed and a moving time from the scanning region to be scanned in advance to the scanning region to be scanned next can be shortened. Accordingly, in the technique of generating an image by scanning a target, scanning of two or more scanning regions freely set in the target and generation of an image based on the scanning can be performed at a higher speed.

In the process according to some example embodiments of the present disclosure, the first control unit 171 performs movement control of the stage 220 while scanning the first scanning region to be scanned in advance using the irradiation unit 210, thereby performing movement control of the reference position of light irradiation based on the position of the lens of the irradiation unit 210 from the start position set for the first scanning region to the start position set for the second scanning region. Accordingly, in the technique of generating an image by scanning a target, scanning of two or more scanning regions freely set in the target and generation of an image based on the scanning can be performed at a much higher speed. The process may also be performed by the control unit 213 instead of being performed by the first control unit 171.

According to the process of some example embodiments of the present disclosure, the first control unit 171 performs control of the scanning such that the position of the scanning trajectory during movement control of the lens position of the irradiation unit 210 while scanning the scanning region and the position of the scanning trajectory when assuming that the scanning region is scanned without performing movement control of the lens of the irradiation unit 210 are at the same position. Accordingly, in scanning of the scanning region using the irradiation unit 210, even when the lens position of the scanner unit 200 is moved by performing movement control of the stage 220, scanning can be performed with high accuracy without shifting the scanning trajectory.

In the above-described example embodiment, scanning of the scanning region is described using an example of raster scanning. However, the irradiation unit 210 may scan the scanning region using other scanning schemes. For example, instead of raster scanning, the irradiation unit 210 may use a radial scan scheme, a concentric scan/spiral scan scheme, a Lissajous scan scheme, a cylindrical scan scheme, or the like.

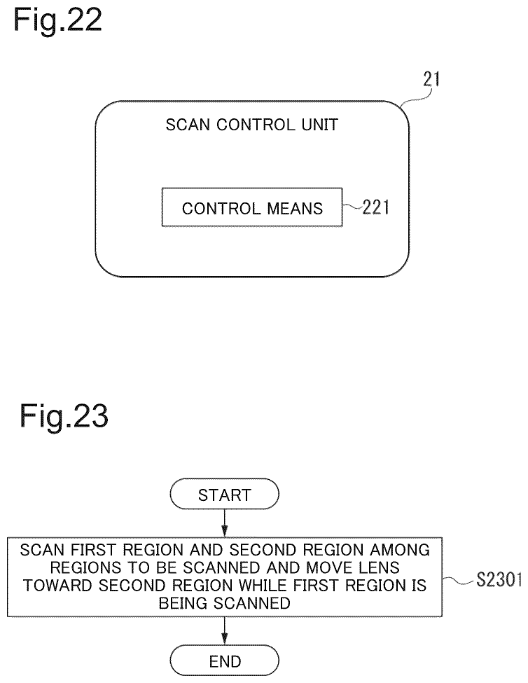

FIG. 22 is a diagram illustrating a configuration of a scanning control device according to some example embodiments of the present disclosure.

FIG. 23 is a diagram illustrating a processing flow of the scanning control device illustrated in FIG. 22.

The scan control unit 21 as an aspect of the scan control device (scanning control device) may include at least control means 221 relevant to the control unit 213 of another example embodiment described above. The control means 221 scans a first region and a second region among regions to be scanned and moves the irradiation unit 210 toward the second region while the first region is being scanned. The irradiation unit 210 may be defined as a lens or a galvano scanner.

### (Hardware Configuration)

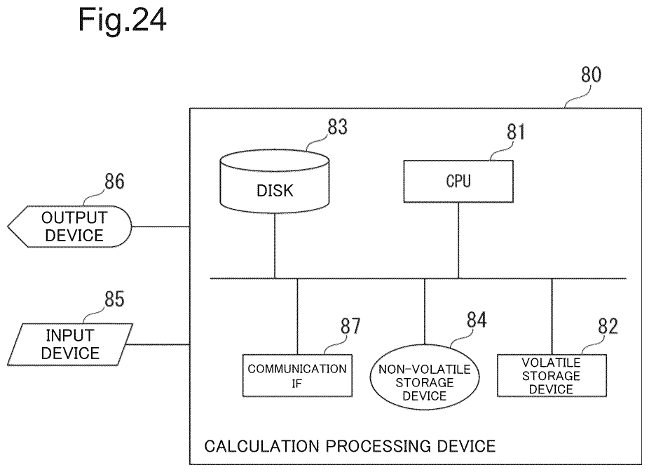

FIG. 24 is a block diagram schematically illustrating a hardware configuration example of a calculation processing device 80 capable of implementing the scan control unit 21 according to each example embodiment of the disclosure.

A configuration example of a hardware resource achieving the scan control unit 21 using one calculation processing device (information processing device or computer) will be described. However, the scan control unit 21 may be achieved by using at least two calculation processing devices physically or functionally.

The calculation processing device 80 includes a central processing unit (Central_Processing_Unit, hereinafter, referred to as “CPU”) 81, a volatile storage device 82, a disk 83, a non-volatile recording medium 84, and a communication interface (hereinafter, referred to as “communication IF”) 87. The calculation processing device 80 may be connectable to an input device 85 and an output device 86. The calculation processing device 80 can transmit and receive information to and from other calculation processing devices and communication devices via the communication IF 87.

The non-volatile recording medium 84 is a computer readable compact disc (Compact_Disc) or digital versatile disc (Digital_Versatile_Disc), for example. The non-volatile recording medium 84 may be a universal serial bus memory (USB memory), a solid state drive (Solid_State_Drive), or the like. The non-volatile recording medium 84 stores such programs even when power is not supplied, and can be carried out. The non-volatile recording medium 84 is not limited to the above-described medium. Instead of the non-volatile recording medium 84, the programs may be carried out via the communication IF 87 and the communication network.

The volatile storage device 82 is computer readable and can temporarily store data. The volatile storage device 82 is a memory such as a dynamic random access memory (DRAM) or a static random access memory (SRAM).

That is, the CPU 81 copies a software program (computer program: hereinafter, simply referred to as “program”) stored in the disk 83 to the volatile storage device 82 at the time of execution and executes an arithmetic process. The CPU 81 reads data necessary for program execution from the volatile storage device 82. When display is required, the CPU 81 displays an output result on the output device 86. When a program is input from outside, the CPU 81 reads the program from the input device 85. The CPU 81 interprets and executes an analysis program (FIGS. 4A and 4B or FIGS. 5A to 5D) in the volatile storage device 82 relevant to a function (process) represented by each unit illustrated in FIG. 2 (or FIGS. 3A to 3C). The CPU 81 executes the process described in each of the above-described example embodiments. That is, here, it can be understood that each of the above-described example embodiments can also be implemented by such an analysis program. It can be understood that each example embodiment of the present disclosure can be implemented by a non-volatile computer-readable recording medium in which the analysis program is recorded.

Some or all of the above example embodiments may be denoted as the following Supplementary Notes, but are not limited to the following description.

### (Supplementary Note 1)

A scanning control device including:
control means for scanning a first region and a second region among regions to be scanned and moving an irradiation unit toward the second region while the first region is being scanned.

### (Supplementary Note 2)

The scanning control device according to Supplementary Note 1, further including:
acquisition means for acquiring information of the first region and the second region among the regions to be scanned in a target and a reference position used to specify a position of the irradiation unit that irradiates the regions to be scanned with scanning light, wherein
the control means performs control of moving the position of the irradiation unit from a start position at which the reference position is first aligned set in the first region to a start position at which the reference position is first aligned in the second region to be scanned next while the first region to be scanned in advance among the regions to be scanned is being scanned.

### (Supplementary Note 3)

The scanning control device according to Supplementary Note 2, wherein
the irradiation unit sets a predetermined range as a scannable range based on the reference position, and
the control means performs movement control of the reference position from a start position set in the first region to a start position set in the second region while scanning the first region, and performs movement control of the reference position to a start position set in the second region before scanning of the first region is completed.

### (Supplementary Note 4)

The scanning control device according to Supplementary Note 3, wherein
the start position of the region to be scanned indicates a position at which at least a scanning start position of the region to be scanned is included in the scannable range of the irradiation unit when the reference position is moved to the start position.

### (Supplementary Note 5)

The scanning control device according to any one of Supplementary Notes 1 to 4, wherein
the control means controls the scanning in such a way that a position of a scanning trajectory in the scanning region and a position of a scanning trajectory when assuming that the region to be scanned is scanned without performing movement control of the irradiation unit become the same position during movement control of the irradiation unit while scanning the region to be scanned.

### (Supplementary Note 6)

The scanning control device according to any one of Supplementary Notes 2 to 4, wherein
the control means performs irradiation control of an irradiation direction of light in the scanning in a direction of canceling a movement amount in a movement direction of the reference position of the irradiation unit and performs control of the scanning in such a way that a position of a scanning trajectory in the scanning region to be scanned and a position of a scanning trajectory when assuming that the region to be scanned is scanned without performing movement control of the reference position of the irradiation unit become the same position.

### (Supplementary Note 7)

A scanning system including:
control means for scanning a first region and a second region among regions to be scanned and moving an irradiation unit toward the second region while the first region is being scanned.

### (Supplementary Note 8)

The scanning control device according to any one of Supplementary Notes 1 to 6, wherein an output wavelength of a light source unit provided in the irradiation unit is changeable.

### (Supplementary Note 9)

An image generation device including:
the scanning control device according to any one of Supplementary Notes 1 to 8; and
means for generating a wavelength-swept optical coherence tomography image of the scanning region.

### (Supplementary Note 10)

An image generation device including:
the scanning control device according to any one of Supplementary Notes 1 to 8; and
means for generating a laser-scanning type captured image of the scanning region, wherein
the laser-scanning type captured image is a three-dimensional image of optical coherence tomography.

### (Supplementary Note 11)

A scanning control method including:
scanning a first region and a second region among regions to be scanned and moving an irradiation unit toward the second region while the first region is being scanned.

### (Supplementary Note 12)

A recording medium storing a program for causing a computer of a scanning control device to function as:
control means for scanning a first region and a second region among regions to be scanned and moving an irradiation unit toward the second region while the first region is being scanned.

This application is based upon and claims the benefit of priority from Japanese patent application No. 2023-001478, filed on Jan. 10, 2023, the disclosure of which is incorporated herein in its entirety by reference.

### INDUSTRIAL APPLICABILITY

The present disclosure may be applied to a scanning control device, a scanning system, a scanning control method, and a recording medium.

### REFERENCE SIGNS LIST

1, 2, 3 optical coherence tomography image generation apparatus
100 stereoscopic image generation unit
110 camera unit
200 scanner unit
210 irradiation unit
220 stage
21 scan control unit (scanning control device)
11, 211 acquisition unit
12, 212 determination unit
13, 213 control unit
214 synthesis unit
171 first control unit
172 second control unit

What is claimed is:

1. A scanning control device comprising:
a controller configured to scan a first region and a second region among regions to be scanned and move an irradiation circuit toward the second region while the first region is being scanned.

2. The scanning control device according to claim 1, further comprising:
an acquisition circuit configured to acquire information of the first region and the second region among the regions to be scanned in a target and a reference position used to specify a position of the irradiation circuit that irradiates the regions to be scanned with scanning light, wherein
the controller performs control of moving the position of the irradiation circuit from a start position at which the reference position is first aligned set in the first region to a start position at which the reference position is first aligned in the second region to be scanned next while the first region to be scanned in advance among the regions to be scanned is being scanned.

3. The scanning control device according to claim 2, wherein
the irradiation circuit sets a predetermined range as a scannable range based on the reference position, and
the controller performs movement control of the reference position from a start position set in the first region to a start position set in the second region while scanning the first region, and performs movement control of the reference position to a start position set in the second region before scanning of the first region is completed.

4. The scanning control device according to claim 3, wherein
the start position of the region to be scanned indicates a position at which at least a scanning start position of the region to be scanned is included in the scannable range of the irradiation circuit when the reference position is moved to the start position.

5. The scanning control device according to claim 1, wherein
the controller controls the scanning in such a way that a position of a scanning trajectory in the scanning region and a position of a scanning trajectory when assuming that the region to be scanned is scanned without performing movement control of the irradiation circuit become the same position during movement control of the irradiation circuit while scanning the region to be scanned.

6. The scanning control device according to claim 2, wherein
the controller performs irradiation control of an irradiation direction of light in the scanning in a direction of canceling a movement amount in a movement direction of the reference position of the irradiation circuit and performs control of the scanning in such a way that a position of a scanning trajectory in the scanning region to be scanned and a position of a scanning trajectory when assuming that the region to be scanned is scanned without performing movement control of the reference position of the irradiation circuit become the same position.

7. (canceled)

8. The scanning control device according to claim 1, wherein an output wavelength of a light source unit provided in the irradiation circuit is changeable.

9. An image generation device comprising:
the scanning control device according to claim 1; and
a generator configured to generate a wavelength-swept optical coherence tomography image of the scanning region.

10. An image generation device comprising:
the scanning control device according to claim 1; and
a generator configured to generate a laser-scanning type captured image of the scanning region, wherein
the laser-scanning type captured image is a three-dimensional image of optical coherence tomography.

11. A scanning control method comprising:
scanning a first region and a second region among regions to be scanned and moving an irradiation circuit toward the second region while the first region is being scanned.

12. A tangible and non-transitory recording medium storing a program for causing a computer of a scanning control device to function as:
a controller configured to scan a first region and a second region among regions to be scanned and moving an irradiation circuit toward the second region while the first region is being scanned.
